(19) United States
(12) Patent Application Publication
(10) Pub. No.: US 2008/0266426 A1
(43) Pub. Date: Oct. 30, 2008

(54) DIGITAL CAMERA

(75) Inventor: Junxian ZENG, Shanghai (CN)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/100,575

(22) Filed: Apr. 10, 2008

(30) Foreign Application Priority Data
Apr. 12, 2007 (CN) 200710090475.4

(51) Int. Cl. H04N 5/217

(52) U.S. Cl. 348/241; 348/E05.078

(57) ABSTRACT

To provide a digital camera which can correct a formed image within the digital camera immediately the image is formed and which utilizes easy calculation formulae and reduces the number of times of calculations for correction, so as to provide least load to be borne by not only the digital camera but also the photographer, there is provided a digital camera having an imaging unit, a display unit, a main control unit, a distortion correction unit, a main storage unit, and an auxiliary storage unit, the distortion correcting unit including a contour retrieval module, an image correction module and a correction control module, the contour retrieval module including a pixel number conversion module, a color space conversion module, a dividing module, a straight line retrieval module and a contour straight line selection module, the image correction module including an intersection point calculation module, a geometric projective conversion formula calculation module, a trimming module and a resize module, an integerizing module, a coordinate transformation module and a pixel interpolation module.

### CROSS-REFERENCE TO RELATED APPLICATIONS

This application is based upon and claims the benefit of priority from the prior Chinese Patent Application No. 200710090475.4, filed on Apr. 12, 2007; the entire contents of which are incorporated herein by reference.

### BACKGROUND OF THE INVENTION

1. Technical Field

The present invention relates to a digital camera which includes a distortion correction unit.

2. Background Art

In recent years, digital cameras have been getting smaller in size, and many people have been ready to enjoy using such small digital cameras. In addition, digital cameras are now used in various ways, and hence, various photographing environments are considered including those where digital cameras are used to take a photograph of a flat object having a rectangular contour such as a whiteboard used in a meeting room or a time table, as well as a three-dimensional structure such as a building.

In general, when an object is photographed from a location inclined at a certain angle relative to the object, since a portion of the object which lies closer to the location where the photographer stands is photographed or captured as looking larger while a farther portion of the object from the photographer captured as looking smaller, a distortion is produced in the resulting image, whereby the image gets unclear. Consequently, there have been proposed and sold many digital cameras provided with a function to correct such a distortion in the image.

For example, Japanese Unexamined Patent Publication No. 10-210359 proposes an invention in which a digital camera is provided with a measuring unit for measuring a distance to an object and an inclination angle relative to a reference plane, so that a distortion produced in an image captured is corrected using the measured values obtained by the measuring unit.

In the conventional digital camera that has been described above, however, since the measuring unit needs to be installed in the camera, there has caused a problem that the casing of the digital camera has to be enlarged, since this is conflict with the fact that recent digital cameras continue to be reduced in size, there are available only a limited number of digital cameras which can accommodate the image correction method of installing therein the measuring unit to correct a distortion in an image captured. In addition, complex correction formulae have been used in many cases, and this has sometimes constituted a load on the digital cameras.

### SUMMARY OF THE INVENTION

The present invention has been made in view of the problems inherent in the related art, and an objective thereof is to provide a digital camera including a distortion correction unit, which enables correction of the distortion of an image captured within the digital camera immediately, which uses easy calculation formulae for correction of the distortion of the image and reduces the number of times of calculation so as to reduce loads borne by not only the digital camera but also the photographer.

According to an aspect of the invention, there is provided a digital camera including:

an imaging unit configured to forming an image of a subject;

a display unit configured to display the image of the subject so formed;

a main control unit configured to control various processing operations;

a distortion correction unit configured to correct a distortion in the formed image;

a main storage unit configured to store image data formed by the imaging unit and processed data of the processing operation performed by the main control unit; and

an auxiliary storage unit configured to store the formed image and corrected image and to be detachable, wherein

the distortion correction unit having:

a contour retrieval module;

an image correction module; and

a correction control module configured to control the contour retrieval module and the image correction module,

the contour retrieval module including:

a pixel number conversion module configured to transform the number of pixels of the formed image;

a color space conversion module for converting a color space;

a dividing module configured to equally divide the image vertically or horizontally;

a straight line retrieval module configured to retrieve a contour straight line; and

a contour straight line selection module configured to select the best candidates from a plurality of contour straight lines retrieved by the straight line retrieval module and to display the best candidates on the display unit,

the image correction module including:

an intersection point calculation module configured to calculate an intersection point of contour straight lines;

a geometric projective conversion formula calculation module configured to calculate a geometric projective conversion formula;

a trimming module configured to trim the image and a resize module configured to resize the image;

an integerizing module configured to round a numeric value calculated by the geometric projective conversion formula calculation module to an integer;

a coordinate transformation module configured to perform an image correction through coordinate transformation; and

a pixel interpolation module configured to perform a pixel interpolation.

In addition, the contour retrieval module performs operations to retrieve a contour straight line in an image of which the number of pixels is reduced by the pixel number conversion module and to obtain end point information of the retrieved contour straight lines.

Furthermore, the distortion correction unit performs a rectangular portion extraction and correction mode which operation to retrieve contour straight lines of a rectangle made up of four sides by the contour retrieval module and correction, and a straight line portion extraction and correction mode which operation to retrieve four or less straight lines by the contour retrieval module and correction.

In addition, the pixel number conversion module performs an operation to reduce the image having the number of pixels of the formed image into an image having 320*240 pixels.

Additionally, the contour straight line selection module switches a predetermined contour straight line candidate displayed on the display unit to another contour straight line candidate for display on the display unit through an operation by the photographer.

Furthermore, the contour straight line selection module causes the display unit to display thereon a vertical line and a horizontal line by lines of different colors.

Thus, according to the invention, due to the aspects that have been described above being provided, it is possible to provide the digital camera including a distortion correction unit which enables correction of an image of a subject within the digital camera immediately the image has been formed, and which uses easy calculation formulae for correction of the image and reduces the number of times of calculation so as to reduce loads borne by not only the digital camera but also the photographer.

### BRIEF DESCRIPTION OF THE DRAWINGS

FIG. 1 is a schematic block diagram of a digital camera,

FIG. 2 is a functional block diagram of a distortion correction unit, and

FIGS. 3 and 4 are flowcharts illustrating a flow of a whole process of a distortion correction operation of the digital camera.

FIG. 5 is a complementary diagram which describes a straight line display switching operation in a rectangular portion extraction and correction mode, and

FIG. 6 is a diagram showing a specific example of a display screen in a preserving type selection screen display operation.

FIG. 7 is a complementary diagram which describes a straight line display switching operation in a bidirectional correction mode of a straight line portion extraction and correction mode.

FIG. 8 is a complementary diagram which describes a straight line display switching operation in a vertical direction correction mode of the straight line portion extraction and correction mode.

FIG. 9 is a complementary diagram which describes a straight line display switching operation in a horizontal direction correction mode of the straight line portion extraction and correction mode.

FIG. 10 is a flowchart of a contour straight line recognition determination operation in the rectangular portion extraction and correction mode,

FIG. 11 is a flowchart of a contour straight line recognition determination operation in the bidirectional correction mode of the straight line portion extraction and correction mode,

FIG. 12 is a flowchart of a contour straight line recognition determination operation in the vertical direction correction mode of the straight line portion extraction and correction mode, and

FIG. 13 is a flowchart of a contour straight line recognition determination operation in the horizontal direction correction mode of the straight line portion extraction and correction mode.

FIG. 14 is a flowchart of a pixel number reduced image correction display operation, and

FIG. 15 is a flowchart of an original image correction and preservation operation.

FIG. 16 is a complementary diagram which describes an intersection point calculation operation,

FIG. 17 is a complementary diagram which describes a relationship between a subject and an image in a geometric projective conversion formula calculation operation, and

FIG. 18 is a complementary diagram which describes a rectangular portion correction in the geometric projective conversion formula calculation operation.

FIG. 19 is a complementary diagram which describes a resize operation, and

FIG. 20 is a complementary diagram which describes a trimming operation and the resize operation in the straight line portion extraction and correction mode.

FIG. 21 is a flowchart of calculation of a condition in an integerizing operation,

FIG. 22 is a flowchart of coordinate transformation of all pixels in a coordinate transforming operation, and

FIG. 23 a flowchart illustrating a pixel interpolation operation.

FIG. 24 shows an image that has been subjected to distortion correction by the rectangular portion extraction and correction mode,

FIG. 25 shows an image that has been subjected to distortion correction by the bidirectional correction mode of the straight line portion extraction and correction mode,

FIG. 26 shows an image that has been subjected to distortion correction by the vertical direction correction mode of the straight line portion extraction and correction mode, and

FIG. 27 shows a formed image which describes a correction by the rectangular portion extraction and correction mode and an image that has been subjected to distortion correction by the same extraction and correction mode.

### DETAILED DESCRIPTION OF THE INVENTION

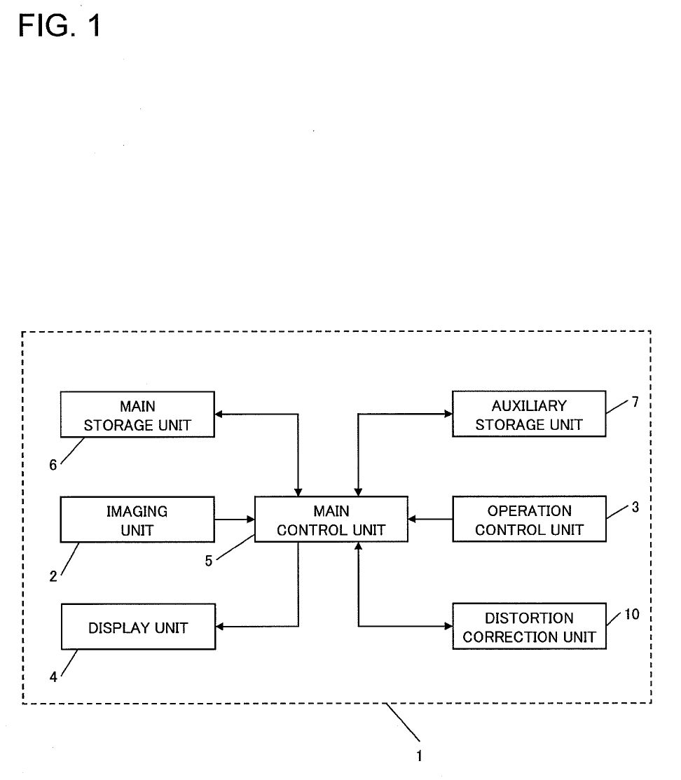

Hereinafter, a digital camera according to a best mode for carrying out the invention will be described based on the drawings. As is shown in FIG. 1, a digital camera 1 according to an embodiment of the invention is such as to include an imaging unit 2 which includes, in turn, an optical system made up of a focusing lens and a zoom lens and an image sensor such as a CCD or a CMOS, an operation control unit 3 which includes, in turn, up/down and left/right buttons, an OK button and a shutter button, and a display unit 4 (such as an LCD) configured to display a formed image or a menu screen.

In addition, the digital camera 1 includes further a main control unit 5 configured to control an imaging operation which are performed by the imaging unit 2, a formed image preserving operation and an image correcting operation, a main storage unit 6 configured to store image data formed by the imaging unit 2 and various types of processed data produced when the main control unit 5 performs predetermined operations, and an auxiliary storage unit 7 such as a memory card which is made detachable so as to also be used on external equipment such as a personal computer.

Furthermore, in general, when a subject is photographed from a position inclined at a certain angle relative to the subject using the digital camera 1, a portion closer to the digital camera 1 is photographed as looking larger, whereas a portion farther from the digital camera 1 is photographed as looking smaller, and hence, a trapezoidal distortion is caused in the formed image. The digital camera 1 includes a distortion correction unit 10 configured to correct such a trapezoidal distortion, whereby the photographer can correct the image so formed within the digital camera 1.

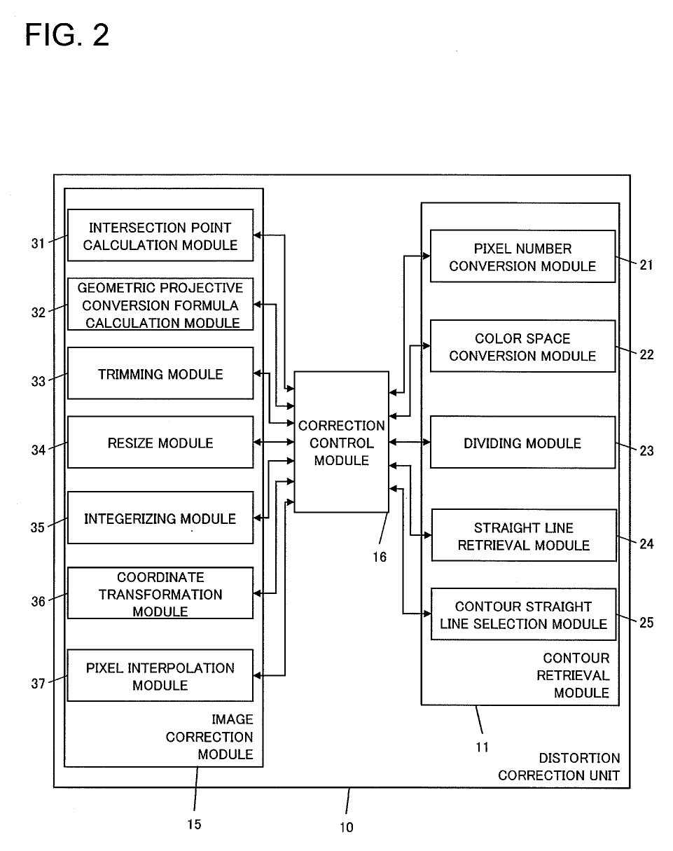

Next, the distortion correction unit in the digital camera 1 according to this embodiment will be described. As is shown in FIG. 2, the distortion correction unit 10 of the embodiment is such as to include a contour retrieval module 11 configured to retrieve a contour straight line of the subject in the formed image, an image correction module 15 and a correction control module 16 configured to control these modules.

This contour retrieval module 11 is such as to include a pixel number conversion module 21 configured to perform an operation in which the image having the number of pixels of the formed image is reduced into an image having 320*240 pixels (76,800 pixels), a color space conversion module 22 configured to convert a color space of RGB format into a color space of YUV format or vice versa, a dividing module 23 configured to divide the formed image in a vertical direction or a horizontal direction, a straight line retrieval module 24 configured to retrieve a contour straight line, and a contour straight line selection module 25 configured to select a best contour straight line candidate from contour straight lines so retrieved by the straight line retrieval module 24.

Here, the color space of YUV format means a format in which a color is represented by three signals such as a Y signal which is a luminance signal, a U signal which is a differential signal of a blue component and a V signal which is a differential signal of a red component and is also referred to as Ycbcr. This format is a format in which emphasis is placed on reproduction of brightness and a color difference from yellow is used for reproduction of color by making use of the characteristics of the human eyes that the eyes are not much sensitive to saturation, and in this YUV format, when compared to the RGB format, the data amount is small, and the calculations for correction become simple, this being the reason that the YUV format is used in this correction operation.

In addition, the image correction module 15 is such as to include an intersection point calculation module 31 configured to calculate an intersection point of the contour straight lines extracted from the formed image, a geometric projective conversion formula calculation module 32 configured to calculate a geometric projective conversion formula based on the optical image forming principle, a trimming module 33, a resize module 34, an integerizing module 35 configured to round a numeric value of projective transformation to an integer, a coordinate transformation module 36 configured to correct the image through coordinate transformation, and a pixel interpolation module 37.

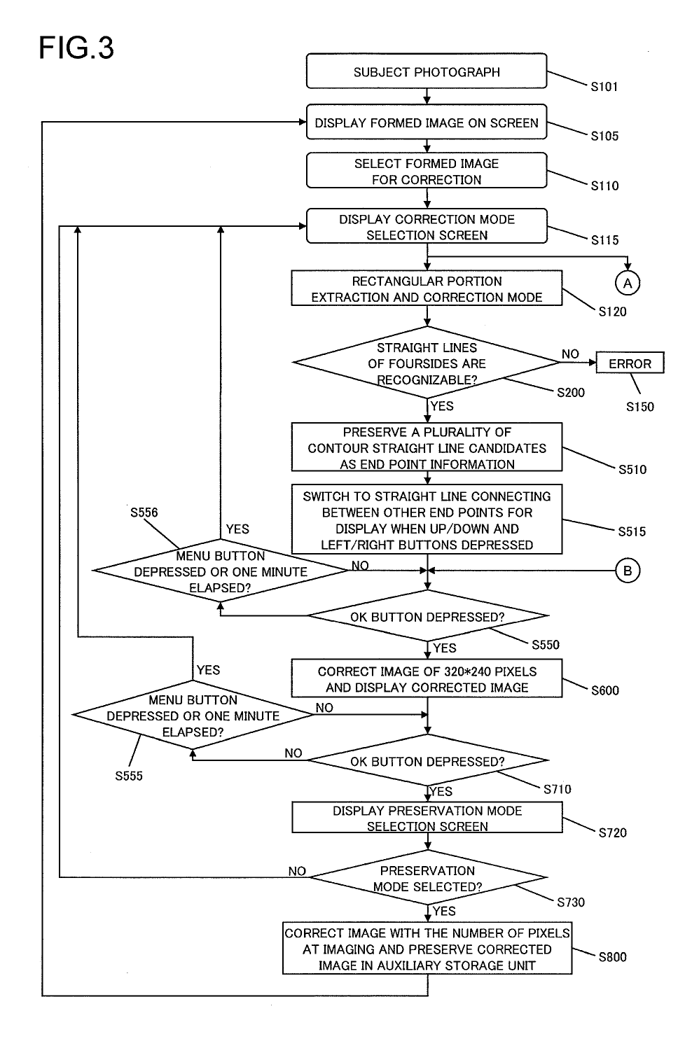

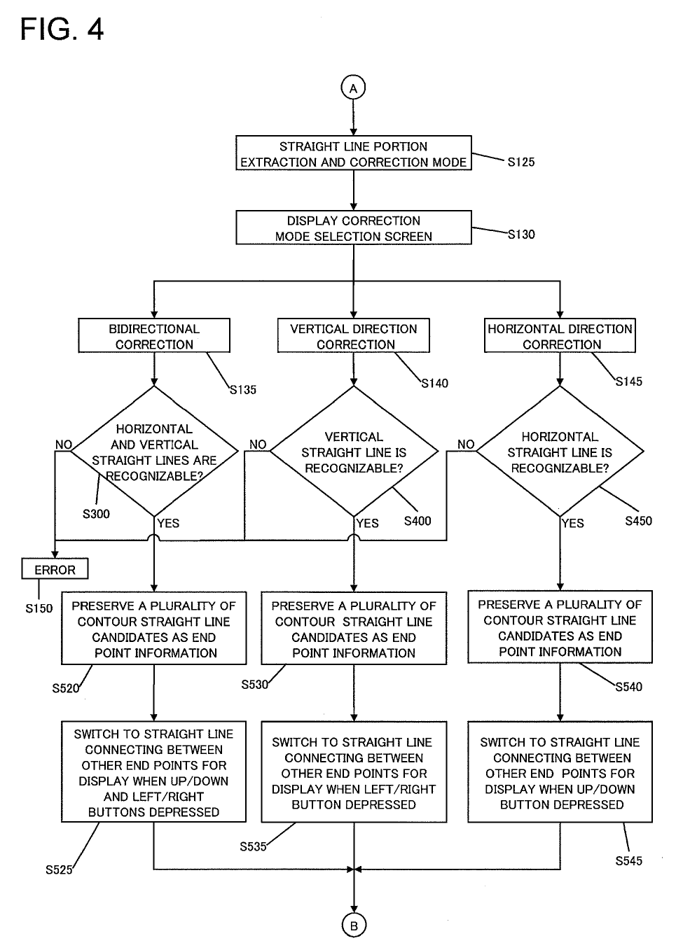

Next, a flow of the processing operation of the distortion correction module 10 of this embodiment will be described using a flowchart shown in FIGS. 3 and 4. When the photographer has photographed a subject (step S101) and switches to a photographed or formed image display mode, the correction control module 16 performs an image display operation in which the formed image that is stored in the main storage unit 6 or the auxiliary storage unit 7 is caused to be displayed on the display unit 4 (step S105), and the photographer selects a picture that is to be subjected to distortion correction from the formed image displayed on the display unit 4 (step S110).

When the photographer selects the picture that is to be subjected to distortion correction (step S110), the correction control module 16 performs a correction mode selection screen display operation in which a selection screen for allowing the photographer to select a mode to be used for the distortion correction from a rectangular portion extraction and correction mode and a straight line portion extraction and correction mode (step S115). The photographer selects the correction mode to the shape of the subject of the formed image to be corrected.

In addition, the rectangular portion extraction and correction mode is a mode for correcting a formed image of a subject which is rectangular like a whiteboard or a business card and of which a rectangular contour can be extracted and is a mode in which since a main part of the formed image resides inside the rectangular contour so extracted, the formed image lying exterior of the contour is totally deleted. In addition, although a bidirectional correction mode in the straight line portion extraction and correction mode is a mode for correcting a formed image of which a rectangular contour can be extracted, this is a mode for correcting a formed image of a subject such as a building and is a mode in which since the formed image lying outside of the extracted rectangular contour needs to be left, the correction is implemented with the formed image lying outside of the contour kept so remaining. On the other hand, a vertical direction correction mode and a horizontal direction correction mode of the straight line portion extraction and correction mode are modes for use when correcting a formed image of a subject such as a building which is not rectangular and is necessary to be corrected by extracting straight line portions as a contour thereof, correcting an formed image which is distorted in only one direction and is necessary to be corrected in the one direction or correcting a formed image in only one direction based on the photographer's arbitrary will in order to maintain the three-dimensionality of the formed image. Namely, being different from the rectangular portion extraction and correction mode, the straight line portion extraction and correction mode is the mode for use in keeping an image of the scenery other than buildings or a human being left as close to as they were as possible and the straight line portion extraction and correction mode is used when correcting the formed images of mainly scenery.

In the correction mode selection screen display operation (step S115), when the photographer selects the rectangular portion extraction and correction mode (step S120), the correction control module 16 causes the contour retrieval module 11 to perform a contour straight line retrieval operation to retrieve a contour straight line from the correction target image which has been converted into the image of the reduced number of pixels and performs a contour straight line recognition determination operation to determine whether or not contour straight lines made up of four sides which make up a rectangle can be recognized from the correction target image (step S200). In the contour straight line recognition determination operation (step S200), if the contour retrieval module 11 can recognize the contour straight lines, the correction control module 16 performs an end point information preservation operation to preserve end point information of the plurality of contour straight lines in the main storage unit 6 (step S510). On the contrary, in the contour straight line recognition determination operation (step S200), if the contour retrieval module 11 cannot recognize the contour straight lines, the correction control module 16 causes a display reading that no correction is possible to be displayed on the display unit 4 and performs an error operation which ends the correction (step S150).

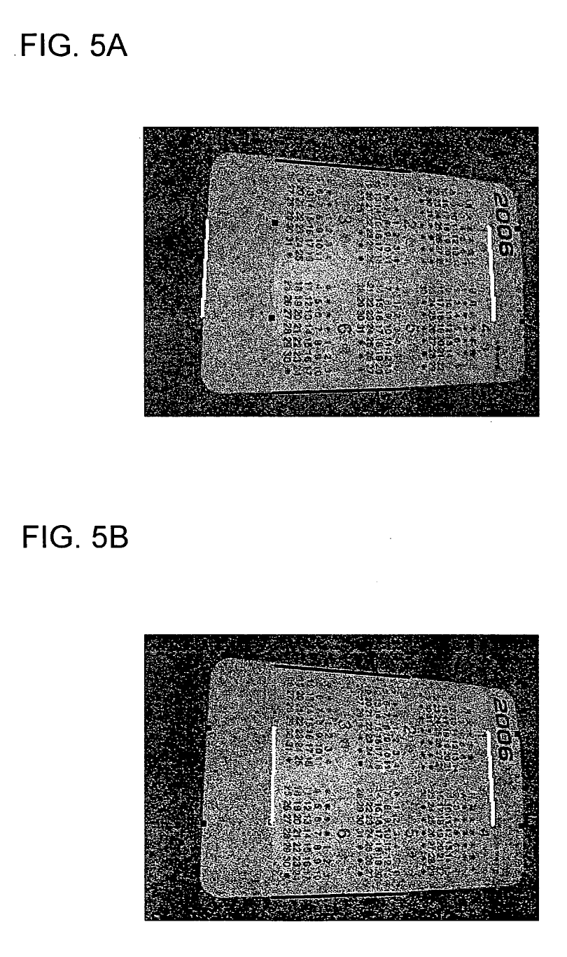

After the end point information preservation operation (step S510), as is shown in FIG. 5A, the contour straight line selection module 25 causes the display unit 4 to display thereon end points of the plurality of straight lines which can be candidate for contour straight lines in the form of dots, selects among the plurality of pieces of end point information the end point information which provides the longest distance between end points and causes the display unit 4 to display thereon the straight lines between the end points of the end point information so selected as the best candidates for the contour straight lines by drawing straight lines. In addition, when the photographer operates the up/down button, the contour straight line selection module 25 performs, as is shown in FIG. 5B, a display switching operation to switch a current display displaying a horizontally drawn red line which connects predetermined end points to a display displaying a red line which connects other endpoints on the display unit 4 (step S515). In addition, when the photographer operates the left/right button, the contour straight line selection module 25 performs a display switching operation to switch a current display displaying a vertically drawn green line which connects predetermined end points to a display displaying a green line which connects other endpoints on the display unit 4 (step S515), allowing the photographer to select the straight lines which make up the contour of the subject.

After the straight line display switching operation (step S515), the correction control module 16 performs an OK button determination operation to determine whether or not the photographer has depressed the OK button (step S550), and if the correction control module 16 determines that the photographer has depressed the OK button, the correction control module 16 performs the correction of image of which pixels are reduced to 320*240, and to display the image in which the distortion has been corrected on the whole of the screen of the display unit 4 with the number of pixels of the image held to the reduced number of pixels (step S600).

In addition, if the OK button is not depressed in the OK button determination operation (step S550), the correction control module 16 determines whether the MENU button has been depressed or one minute has elapsed with no entry (step S556), the correction control module 16 returns to the correction mode selection screen display operation (step S115) when the MENU button has been depressed or one minutes has elapsed with no entry. In addition, if the MENU button is not depressed and one minute has not elapsed, the correction control module 16 performs the OK button determination operation again (step S550).

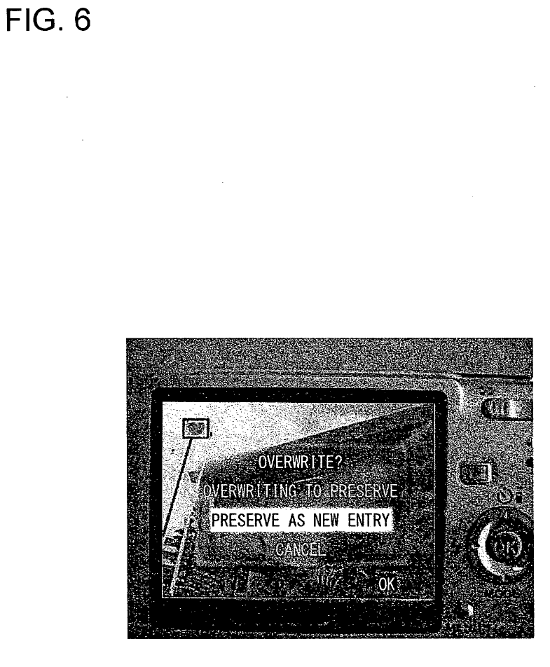

After the pixel number reduced image correction display operation (step S600), the correction control module 16 performs an OK button determination operation to determined whether or not the OK button has been depressed (step S710), and if the correction control module 16 determines that the OK button has been depressed, as is shown in FIG. 6, the correction control module 16 performs a preservation mode selection screen display operation to display icons of “overwriting to preserve,” “preserve as new entry,” and “cancel” as a preservation mode selection screen on the display unit 4 (step S720).

In addition, if the OK button is not depressed in the OK button determination operation (step S710), the correction control module 16 determines whether the MENU button has been depressed or one minute has elapsed with no entry (step S555), the correction control module 16 returns to the correction mode selection screen display operation (step S115) when the MENU button has been depressed or one minutes has elapsed with no entry. In addition, if the MENU button is not depressed and one minute has not elapsed, the correction control module 16 performs the OK button determination operation again (step S710).

After the preservation mode selection screen display operation (step S720), the correction control module 16 performs a selected icon determination operation to determine which preservation mode icon the photographer has selected (step S730). Then, according to the preservation mode determined in the selected icon determination operation (step S730), the correction control module 16 performs an original image correction and preservation operation to preserve the image that has been so corrected in the auxiliary storage unit 7 (step S800) and returns to the image display operation (step S105). In addition, in the selected icon determination operation (step S730), if the photographer selects the “cancel” icon, the correction control module 16 performs the correction mode selection screen display operation (step S115).

In the correction mode selection screen display operation (step S115), if the photographer selects the straight line portion extraction and correction mode (step S125), the correction control module 16 performs a correction mode selection screen display operation to cause the display unit 4 to display thereon a correction mode selection screen for the photographer to select a correction mode from the bidirectional correction mode, the vertical direction correction mode and the horizontal direction correction mode (step S130).

In the correction mode selection screen display operation (step S130), if the photographer selects the bidirectional correction mode (step S135), the correction control module 16 causes the contour retrieval module 11 to perform a contour straight line retrieval operation to retrieve contour straight lines from the correction target image of which the number of pixels has been converted into the image of the reduced number of pixels and then performs a contour straight line recognition determination operation to determine whether or not vertical and horizontal contour straight lines can be recognized from the correction target image (step S300). In this contour straight line recognition determination operation (step S300), if the contour retrieval module 11 can recognize the contour straight lines, the correction control module 16 performs an end point information preservation operation to preserve end points of the retrieved contour straight lines as end point information in the main storage unit 6 (step S520) In addition, in the contour straight line recognition determination operation (step S300), if the contour retrieval module 11 recognizes no contour straight line, the correction control module 16 performs the error operation (step S150).

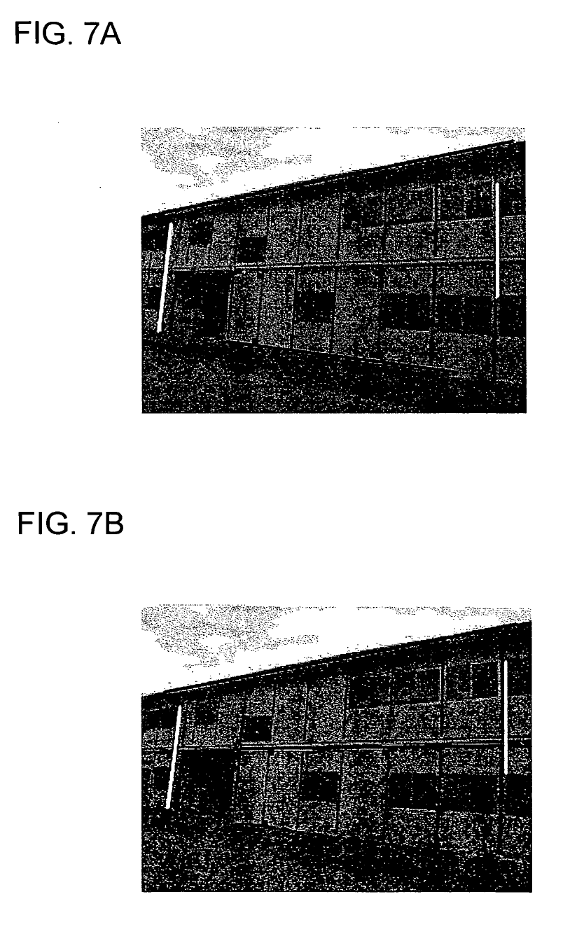

After the end point information preservation operation (step S520), as is shown in FIG. 7A, the contour straight line selection module 25 causes the display unit 4 to display thereon end points of the plurality of straight lines which can be candidate for contour straight lines in the form of dots, selects among the plurality of pieces of end point information the end point information which provides the longest distance between end points and causes the display unit 4 to display thereon the straight lines between the end points of the end point information so selected as one of candidates for the contour straight lines by drawing straight lines. In addition, when the photographer operates the up/down button, the contour straight line selection module 25 performs, as is shown in FIG. 7B, a display switching operation to switch a current display displaying a horizontally drawn red line which connects predetermined end points to a display displaying a red line which connects other endpoints on the display unit 4 (step S525). Then, when the photographer operates the left/right button, the contour straight line selection module 25 performs a display switching operation to switch a current display displaying a vertically drawn green line which connects predetermined end points to a display displaying a green line which connects other end points on the display unit 4 (step S525), allowing the photographer to select the straight lines which is the basis of correction.

After the straight line display switching operation (step S525), the correction control module 16 performs, as in the rectangular portion extraction and correction mode, performs the OK button determination operation (step S550), the pixel number reduced image correction display and operation (step S600), the OK button determination operation (step S710), the preservation mode selection screen display operation (step S720), the selected icon determination operation (step S730) and the original image correction and preservation operation (step S800) sequentially in that order.

In addition, in the correction mode selection screen display operation (step S130), if the photographer selects the vertical correction mode (step S140), the correction control module 16 causes the contour retrieval module 11 to perform contour straight line retrieval operation to retrieve a vertical contour straight lines from the correction target image of which the number of pixels has been converted into the image of the reduced number of pixels and then performs a contour straight line recognition determination operation to determine whether or not vertical contour straight lines can be recognized from the correction target image (step S400). In this contour straight line recognition determination operation (step S400), if the contour retrieval module 11 can recognize vertical straight lines, the correction control module 16 performs an end point information preserving operation to preserve end points of the retrieved contour straight lines as end point information in the main storage unit 6 (step S530). In addition, in the contour straight line recognition determination operation (step S400), if the contour retrieval module 11 recognizes no contour straight line, the correction control module 16 performs the error operation (step S150).

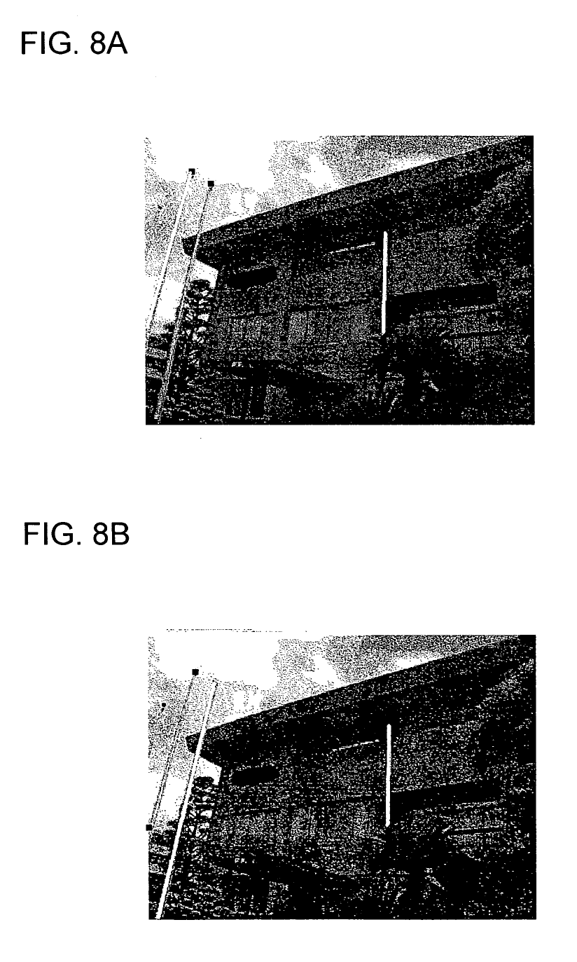

After the end point information preservation operation (step S530), as is shown in FIG. 8A, the contour straight line selection module 25 causes the display unit 4 to display thereon end points of the vertical straight lines which can be candidate for contour straight lines in the form of dots, selects among the plurality of pieces of end point information the end point information which provides the longest distance between end points and causes the display unit 4 to draw the straight lines between the end points of the end point information so selected as one of candidates for the contour straight lines for display thereon. In addition, when the photographer operates the left/right button, the contour straight line selection module 25 performs, as is shown in FIG. 8B, a display switching operation to switch a current display displaying a currently drawn green line which connects predetermined end points to a display displaying a green line which connects other end points on the display unit 4 (step S535), allowing the photographer to select the straight lines which is the basis of correction.

After the straight line display switching operation (step S535), the correction control module 16 performs, as in the respective correction modes described heretofore, performs the OK button determination operation (step S550), the pixel number reduced image correction and display operation (step S600), the OK button determination operation (step S710), the preservation mode selection screen display operation (step S720), the selected icon determination operation (step S730) and the original image correction and preservation operation (step S800) sequentially in that order.

Furthermore, in the correction mode selection screen display operation (step S130), if the photographer selects the horizontal correction mode (step S145), the correction control module 16 causes the contour retrieval module 11 to perform a contour straight line retrieval operation to retrieve horizontal contour straight lines from the correction target image of which the number of pixels has been converted into the image of the reduced number of pixels and then performs a contour straight line recognition determination operation to determine whether or not horizontal contour straight lines can be recognized from the correction target image (step S450). In this contour straight line recognition determination operation (step S450), if the contour retrieval module 11 can recognize horizontal straight lines, the correction control module 16 performs an end point information preserving operation to preserve end points of the retrieved contour straight lines as end point information in the main storage unit 6 (step S540). In addition, in the contour straight line recognition determination operation (step S450), if the contour retrieval module 11 recognizes no contour straight line, the correction control module 16 performs the error operation (step S150).

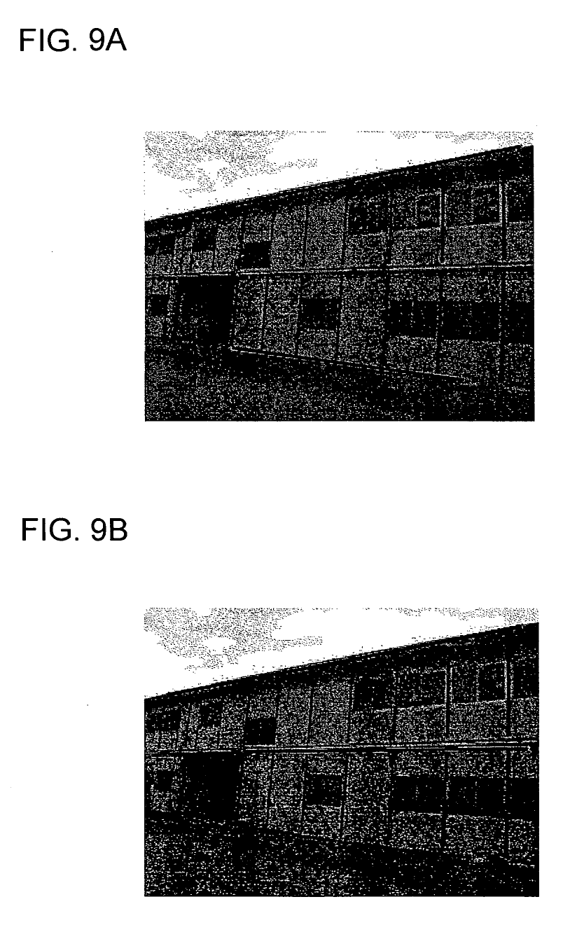

After the end point information preservation operation (step S540), as is shown in FIG. 9A, the contour straight line selection module 25 causes the display unit 4 to display thereon end points of the horizontal straight lines which can be candidate for contour straight lines in the form of dots, selects among the plurality of pieces of end point information the end point information which provides the longest distance between end points and causes the display unit 4 to draw the straight lines between the end points of the end point information so selected as one of candidates for the contour straight lines for display thereon. When the photographer operates the up/down button, the contour straight line selection module 25 performs, as is shown in FIG. 9B, a display switching operation to switch a current display displaying a red line which connects predetermined end points to a display displaying a red line which connects other end points on the display unit 4 (step S545), allowing the photographer to select the straight lines which is the basis of correction.

After the straight line display switching operation (step S545), the correction control module 16 performs, as in the respective correction modes described heretofore, performs the OK button determination operation (step S550), the pixel number reduced image correction and display operation (step S600), the OK button determination operation (step S710), the preservation mode selection screen display operation (step S720), the selected icon determination operation (step S730) and the original image correction and preservation operation (step S800) sequentially in that order.

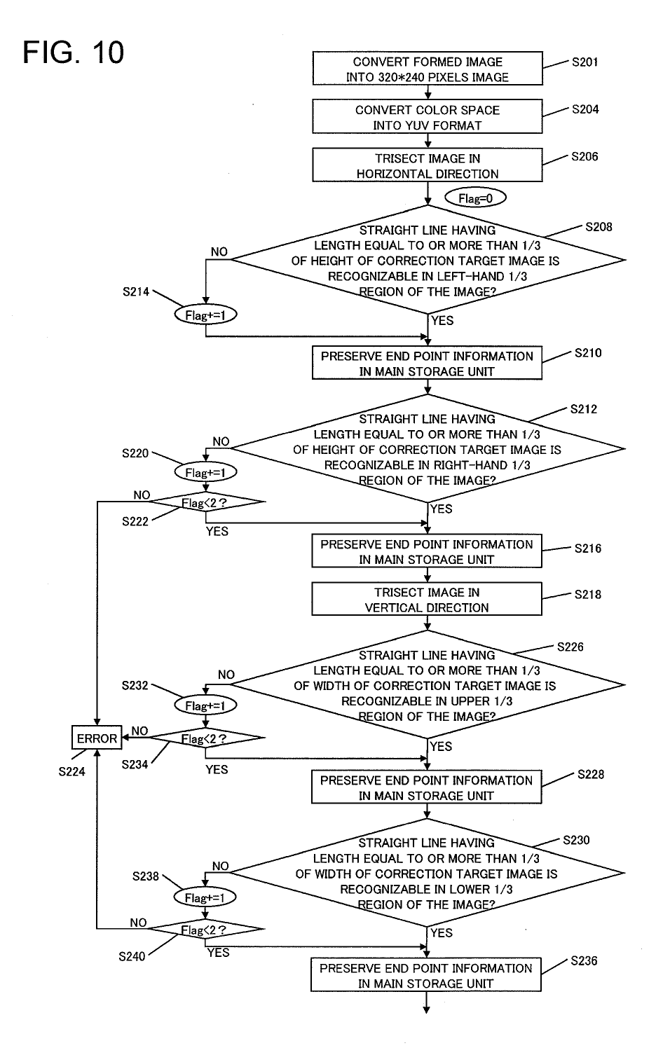

Next, the contour straight line recognition determination operation (step S200) in the rectangular portion extraction and correction mode shown in FIG. 3 will be described using a flowchart shown in FIG. 10. The correction control module 16 performs a pixel number reducing operation to cause the pixel number conversion module 21 to convert the correction target formed image into an image of 320*240 pixels (step S201), performs a color space change operation to cause the color space conversion module 22 to convert the color space of the reduced pixel number image into the YUV format (step S204), and performs a horizontal direction diving operation to cause the dividing module 23 to trisect the formed image in the horizontal direction (step S206).

After the horizontal direction dividing operation (step S206), the correction control module 16 firstly sets a Flag=0, causes the straight line retrieval module 24 to retrieve a straight line which has a length corresponding to one third or more of the height of the correction target image within a region occupying one third of the correction target image on a left-hand side thereof, and performs a left-hand region straight line recognition determination operation to determine whether or not the target straight line can be recognized in the region in question (step S208). In this left-hand region straight line recognition determination operation (step S208), if the correction control module 16 determines that the target straight line can be recognized, the correction control module 16 performs a left-hand region straight line preserving operation to preserve end point information in the main storage unit 6 as candidates for contour straight lines (step S210).

In addition, in the left-hand region straight line recognition determination operation (step S208), if the correction control module 16 determines that no target straight line can be recognized, the correction control module 16 performs a Flag adding operation to add 1 (one) to the Flag (step S214) and performs the left-hand region straight line preserving operation to adopt a left-hand frame of the image as a contour straight line and to preserve the end point information in the main storage unit 6 (step S210).

Then, the correction control module 16 causes the straight line retrieval module 24 to retrieve a straight line which has a length corresponding to one third or more of the height of the correction target image within a region occupying one third of the correction target image on a right-hand side thereof, and performs a right-hand region straight line recognition determination operation to determine whether or not the target straight line can be recognized in the region in question (step S212). In this right-hand region straight line recognition determination operation (step S212), if the correction control module 16 determines that the target straight line can be recognized, the correction control module 16 performs a right-hand region straight line preserving operation to preserve end point information in the main storage unit 6 as candidates for contour straight lines (step S216). Then, the correction control module 16 causes the dividing module 23 to perform a vertical dividing operation to trisect the image in the vertical direction (step S218).

In addition, in the right-hand region straight line recognition determination operation (step S212), if the correction control module 16 determines that no target straight line can be recognized, the correction control module 16 performs a Flag adding operation to add 1 (one) to the Flag (step S220) and performs a Flag determination operation to determine whether or not the total of Flags is less than 2 (two) (step S222). In this Flag determination operation (step S222), if the total of Flags is 2 (two), the correction control module 16 performs the error operation (step S224), whereas if the total of Flags is 1 (one), the correction control module 16 performs a right-hand region straight line preserving operation to adopt a right-hand frame of the image as a contour straight line and to preserve the end point information in the main storage unit 6 (step S216).

After the vertical direction dividing operation (step S218), the correction control module 16 causes the straight line retrieval module 24 to retrieve to see whether or not a straight line can be recognized which has a length corresponding to one third or more of the width of the correction target image within a region occupying one third of the correction target image on an upper side thereof, and performs an upper region straight line recognition determination operation to determine whether or not the target straight line can be recognized in the region in question (step S226). In this upper region straight line recognition determination operation (step S226), if the correction control module 16 determines that the target straight line can be recognized, the correction control module 16 performs an upper region straight line preserving operation to preserve end point information in the main storage unit 6 as candidates for contour straight lines (step S228).

In addition, in the upper region straight line recognition determination operation (step S226), if the correction control module 16 determines that no target straight line can be recognized, the correction control module 16 performs a Flag adding operation to add 1 (one) to the Flag (step S232) and performs a Flag determination operation to determine whether or not the total of Flags is less than 2 (two) (step S234). In this Flag determination operation (step S234), if the total of Flags is 2 (two), the correction control module 16 performs the error operation (step S224), whereas if the total of Flags is 1 (one), the correction control module 16 performs an upper region straight line preserving operation to adopt an upper frame of the image as a contour straight line and to preserve the end point information in the main storage unit 6 (step S228).

In addition, after the upper region straight line preserving operation (step S228), the correction control module 16 causes the straight line retrieval module 24 to retrieve to see whether or not a straight line can be recognized which has a length corresponding to one third or more of the width of the correction target image within a region occupying one third of the correction target image on a lower side thereof, and performs a lower region straight line recognition determination operation to determine whether or not the target straight line can be recognized in the region in question (step S230). In this lower region straight line recognition determination operation, if the correction control module 16 determines that the target straight line can be recognized, the correction control module 16 performs a lower region straight line preserving operation to preserve end point information in the main storage unit 6 as candidates for contour straight lines (step S236).

In addition, in the lower region straight line recognition determination operation (step S230), if the correction control module 16 determines that no target straight line can be recognized, the correction control module 16 performs a Flag adding operation to add 1 (one) to the Flag (step S238) and performs a Flag determination operation to determine whether or not the total of Flags is less than 2 (two) (step S240). In this Flag determination operation (step S240), if the total of Flags is 2 (two), the correction control module 16 performs the error operation (step S224), whereas if the total of Flags is 1 (one), the correction control module 16 performs a lower region straight line preserving operation to adopt a lower frame of the image as a contour straight line and to preserve the end point information in the main storage unit 6 (step S236).

Namely, the contour straight line recognition determination operation in the rectangular portion extraction and correction mode is such that in the event that the straight line having the length equal to or longer than the predetermined length can be recognized in three or more regions of the four regions which are made up of the upper and lower side one-third regions and the left- and right-hand side one-third regions of the correction target image, it is determined that the correction is possible, whereas in the event that the straight line having the length equal to or longer than the predetermined length cannot be recognized in two or more regions of the four regions, it is determined that the correction is not possible, allowing the photographer to select the other correction modes.

This rectangular portion extraction and correction mode is effective when the ratio of the portion occupied by the subject to the whole region of the formed image is large, that is, when correcting the image of a subject such as a business card or a whiteboard but is unsuitable for correction when the ratio of the portion occupied by the subject to the whole region of the formed image is small.

In addition, after the contour straight line recognition determination operation (step S200) has ended, the correction control module 16 preserves end point information on the plurality of straight lines recognized in the main storage unit 6 (step S510) and causes the display unit 4 to display the end point information of the plurality of straight lines recognized in the form of dots, and the contour straight line selection module 25 automatically selects from the straight lines recognized, respectively, in the four regions the straight line having the longest length and draws a straight line which connects between the end points of the straight line so selected for display (step S515).

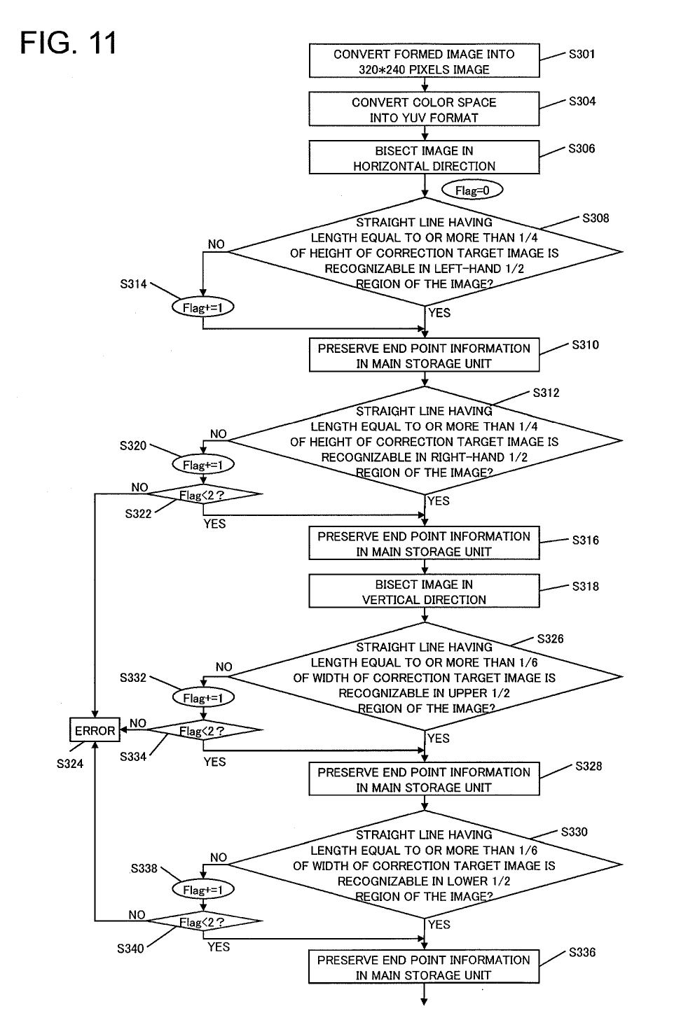

The contour straight line recognition determination operation (step S300) in the bidirectional correction mode shown in FIG. 4 will be described using a flowchart shown in FIG. 11. The correction control module 16 performs a pixel number reducing operation to cause the pixel number conversion module 21 to convert the correction target formed image into an image of 320*240 pixels (step S301), performs a color space change operation to cause the color space conversion module 22 to convert the color space of the reduced pixel number image into the YUV format (step S304), and performs a horizontal direction diving operation to cause the dividing module 23 to bisect the formed image in the horizontal direction (step S306).

After the horizontal direction dividing operation (step S306), the correction control module 16 firstly sets a Flag=0, causes the straight line retrieval module 24 to retrieve a straight line which has a length corresponding to one fourth or more of the height of the correction target image within a region occupying one half of the correction target image on a left-hand side thereof, and performs a left-hand region straight line recognition determination operation to determine whether or not the target straight line can be recognized in the region in question (step S308). In this left-hand region straight line recognition determination operation (step S308), if the correction control module 16 determines that the target straight line can be recognized, the correction control module 16 performs a left-hand region straight line preserving operation to preserve end point information in the main storage unit 6 as candidates for contour straight lines (step S310).

In addition, in the left-hand region straight line recognition determination operation (step S308), if the correction control module 16 determines that no target straight line can be recognized, the correction control module 16 performs a Flag adding operation to add 1 (one) to the Flag (step S314) and performs the left-hand region straight line preserving operation to adopt a left-hand frame of the image as a contour straight line and to preserve the end point information in the main storage unit 6 (step S310).

Then, after the left-hand region straight line preserving operation (S310), the correction control module 16 causes the straight line retrieval module 24 to retrieve a straight line which has a length corresponding to one fourth or more of the height of the correction target image within a region occupying one half of the correction target image on a right-hand side thereof, and performs a right-hand region straight line recognition determination operation to determine whether or not the target straight line can be recognized in the region in question (step S312). In this right-hand region straight line recognition determination operation (step S312), if the correction control module 16 determines that the target straight line can be recognized, the correction control module 16 performs a right-hand region straight line preserving operation to preserve end point information in the main storage unit 6 as candidates for contour straight lines (step S316). Then, the correction control module 16 causes the dividing module 23 to perform a vertical dividing operation to bisect the image in the vertical direction (step S318).

In addition, in the right-hand region straight line recognition determination operation (step S316), if the correction control module 16 determines that no target straight line can be recognized, the correction control module 16 performs a Flag adding operation to add 1 (one) to the Flag (step S320) and performs a Flag determination operation to determine whether or not the total of Flags is less than 2 (two) (step S322). In this Flag determination operation (step S322), if the total of Flags is 2 (two), the correction control module 16 performs the error operation (step S324), whereas if the total of Flags is 1 (one), the correction control module 16 performs a right-hand region straight line preserving operation to adopt a right-hand frame of the image as a contour straight line and to preserve the end point information in the main storage unit 6 (step S316).

After the vertical direction dividing operation (step S318), the correction control module 16 causes the straight line retrieval module 24 to retrieve to see whether or not a straight line can be recognized which has a length corresponding to one sixth or more of the width of the correction target image within a region occupying one half of the correction target image on an upper side thereof, and performs an upper region straight line recognition determination operation to determine whether or not the target straight line can be recognized in the region in question (step S326). In this upper region straight line recognition determination operation (step S326), if the correction control module 16 determines that the target straight line can be recognized, the correction control module 16 performs an upper region straight line preserving operation to preserve end point information in the main storage unit 6 as candidates for contour straight lines (step S328).

In addition, in the upper region straight line recognition determination operation (step S326), if the correction control module 16 determines that no target straight line can be recognized, the correction control module 16 performs a Flag adding operation to add 1 (one) to the Flag (step S332) and performs a Flag determination operation to determine whether or not the total of Flags is less than 2 (two) (step S334). In this Flag determination operation (step S334), if the total of Flags is 2 (two), the correction control module 16 performs the error operation (step S324), whereas if the total of Flags is 1 (one), the correction control module 16 performs an upper region straight line preserving operation to adopt an upper frame of the image as a contour straight line and to preserve the end point information in the main storage unit 6 (step S328).

In addition, after the upper region straight line preserving operation (step S328), the correction control module 16 causes the straight line retrieval module 24 to retrieve to see whether or not a straight line can be recognized which has a length corresponding to one sixth or more of the width of the correction target image within a region occupying one half of the correction target image on a lower side thereof, and performs a lower region straight line recognition determination operation to determine whether or not the target straight line can be recognized in the region in question (step S330). In this lower region straight line recognition determination operation (step S330), if the correction control module 16 determines that the target straight line can be recognized, the correction control module 16 performs a lower region straight line preserving operation to preserve end point information in the main storage unit 6 as candidates for contour straight lines (step S336).

In addition, in the lower region straight line recognition determination operation (step S330), if the correction control module 16 determines that no target straight line can be recognized, the correction control module 16 performs a Flag adding operation to add 1 (one) to the Flag (step S338) and performs a Flag determination operation to determine whether or not the total of Flags is less than 2 (two) (step S340). In this Flag determination operation (step S340), if the total of Flags is 2 (two), the correction control module 16 performs the error operation (step S324), whereas if the total of Flags is 1 (one), the correction control module 16 performs a lower region straight line preserving operation to adopt a lower frame of the image as a contour straight line and to preserve the end point information in the main storage unit 6 (step S336).

Namely, the contour straight line recognition determination operation in the bidirectional correction mode of the straight line portion extraction and correction mode is such that in the event that the straight line having the length equal to or longer than the predetermined length can be recognized in three or more regions of the four regions which are made up of the upper and lower half regions and the left and right half regions of the target correction image, it is determined that the correction is possible, whereas in the event that the straight line having the length equal to or longer than the predetermined length cannot be recognized in two or more regions of the four regions, it is determined that the correction is not possible, allowing the photographer to select the other correction modes.

When comparing the rectangular portion extraction and correction mode with the bidirectional correction mode of the straight line portion extraction and correction mode, since in the event that the straight line having the length equal to or longer than the predetermined length can be recognized in the upper and lower half portions of the image and the left and right half portion of the image, it is determined that the correction is possible in the bidirectional correction mode of the straight line portion extraction and correction mode, the correction becomes possible even when the ratio of the region occupied by the subject to the whole region of the formed image is small, and hence the bidirectional correction mode is effective when the subject is a building or the like.

In addition, after the contour straight line recognition determination operation (step S300) has ended, the correction control module 16 preserves end point information in the main storage unit 6 (step S520) and causes the display unit 4 to display the end point information on the plurality of straight lines recognized in the form of dots, and the contour straight line selection module 25 automatically selects from the straight lines recognized, respectively, in the four regions the straight line having the longest length as a best candidate for the contour straight line and draws a straight line which connects between the end points of the straight line so selected for display (step S525).

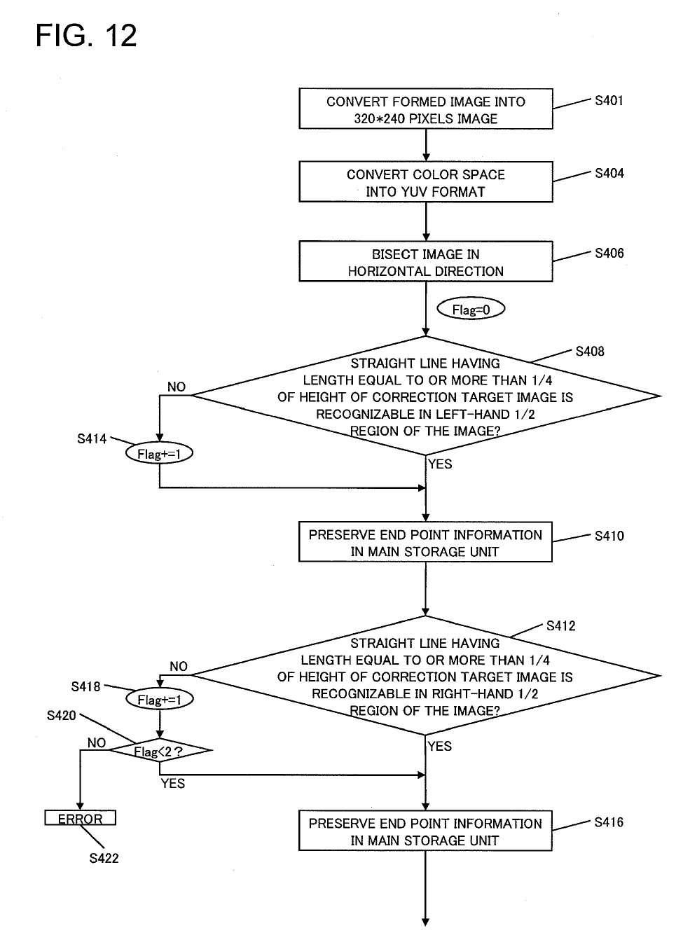

Next, the contour straight line recognition determination operation (step S400) in the vertical direction correction mode shown in FIG. 4 will be described using a flowchart shown in FIG. 12. The correction control module 16 performs a pixel number reducing operation to cause the pixel number conversion module 21 to convert the correction target formed image into an image of 320*240 pixels (step S401), performs a color space change operation to cause the color space conversion module 22 to convert the color space of the reduced pixel number image into the YUV format (step S404), and performs a horizontal direction diving operation to cause the dividing module 23 to bisect the formed image in the horizontal direction (step S406).

After the horizontal direction dividing operation (step S406), the correction control module 16 firstly sets a Flag=0, causes the straight line retrieval module 24 to retrieve a straight line which has a length corresponding to one fourth or more of the height of the correction target image within a left half region of the correction target image, and performs a left-hand region straight line recognition determination operation to determine whether or not the target straight line can be recognized in the region in question (step S408). In this left-hand region straight line recognition determination operation (step S408), if the correction control module 16 determines that the target straight line can be recognized, the correction control module 16 performs a left-hand region straight line preserving operation to preserve end point information in the main storage unit 6 as candidates for contour straight lines (step S410).

In addition, in the left-hand region straight line recognition determination operation (step S408), if the correction control module 16 determines that no target straight line can be recognized, the correction control module 16 performs a Flag adding operation to add 1 (one) to the Flag (step S414) and performs the left-hand region straight line preserving operation to adopt a left-hand frame of the image as a contour straight line and to preserve the end point information in the main storage unit 6 (step S410).

Then, in the left-hand region straight line preserving operation (step S410), the correction control module 16 causes the straight line retrieval module 24 to retrieve a straight line which has a length corresponding to one fourth or more of the height of the correction target image within a right half region of the correction target image, and performs a right-hand region straight line recognition determination operation to determine whether or not the target straight line can be recognized in the region in question (step S412). In this right-hand region straight line recognition determination operation (step S412), if the correction control module 16 determines that the target straight line can be recognized, the correction control module 16 performs a right-hand region straight line preserving operation to preserve end point information in the main storage unit 6 as candidates for contour straight lines (step S416) and ends the contour straight line recognition determination operation.

In addition, in the right-hand region straight line recognition determination operation (step S412), if the correction control module 16 determines that no target straight line can be recognized, the correction control module 16 performs a Flag adding operation to add 1 (one) to the Flag (step S418) and performs a Flag determination operation to determine whether or not the total of Flags is less than 2 (two) (step S420). In this Flag determination operation (step S420), if the total of Flags is 2 (two), the correction control module 16 performs the error operation (step S422), whereas if the total of Flags is 1 (one), the correction control module 16 performs a right-hand region straight line preserving operation to adopt a right-hand frame of the image as a contour straight line and to preserve the end point information in the main storage unit 6 (step S416), and ends the contour straight line recognition determination operation.

Namely, the operation of the straight line retrieval module in the vertical direction correction mode of the straight line portion extraction and correction mode is such that in the event that even only one straight line having the predetermined length or longer can be recognized in the left and right half regions of the formed image, the correction becomes possible, and when comparing the bidirectional correction mode with the vertical direction correction mode, while the straight line having the predetermined length or longer needs to be recognized within at least three regions when attempting to perform a correction in the bidirectional correction mode, in the vertical direction correction mode, in the event that the straight line having the predetermined length or longer can be recognized within one region, the correction becomes possible, and therefore, the latter correction mode is effective when attempting to correct a scenic image or the like.

In addition, after the contour straight line recognition determination operation (step S400) has ended, the correction control module 16 preserves end point information on the plurality of straight lines recognized (step S530) and causes the display unit 4 to display the end point information on the plurality of straight lines recognized in the form of dots, and the contour straight line selection module 25 automatically selects from the straight lines recognized, respectively, in the two regions the straight line having the longest length as a best candidate for the contour straight line and draws a straight line which connects between the end points of the straight line so selected for display (step S535).

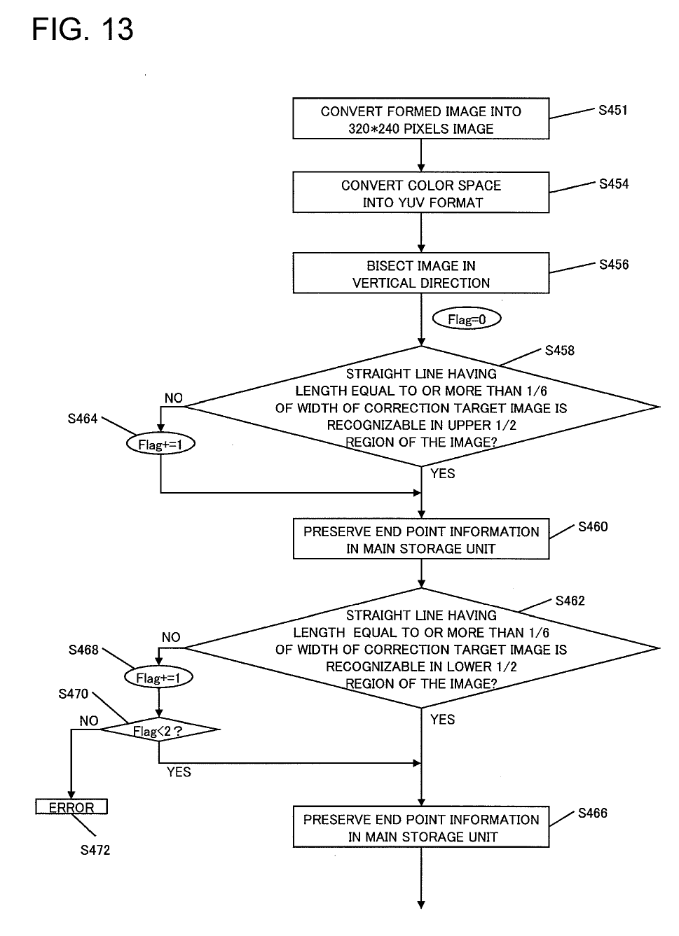

Next, the contour straight line recognition determination operation (step S450) in the horizontal direction correction mode shown in FIG. 4 will be described using a flowchart shown in FIG. 13. The correction control module 16 performs a pixel number reducing operation to cause the pixel number conversion module 21 to convert the correction target formed image into an image of 320*240 pixels (step S451), performs a color space change operation to cause the color space conversion module 22 to convert the color space of the reduced pixel number image into the YUV format (step S454), and performs a vertical direction diving operation to cause the dividing module 23 to bisect the formed image in the vertical direction (step S456).

After the vertical direction dividing operation (step S456), the correction control module 16 firstly sets a Flag=0, causes the straight line retrieval module 24 to retrieve a straight line which has a length corresponding to one sixth or more of the width of the correction target image within an upper half region of the correction target image, and performs an upper region straight line recognition determination operation to determine whether or not the target straight line can be recognized in the region in question (step S458). In this upper region straight line recognition determination operation (step S458), if the correction control module 16 determines that the target straight line can be recognized, the correction control module 16 performs an upper region straight line preserving operation to preserve end point information in the main storage unit 6 as candidates for contour straight lines (step S460).

In the upper region straight line recognition determination operation (step S458), if the correction control module 16 determines that no target straight line can be recognized, the correction control module 16 performs a Flag adding operation to add 1 (one) to the Flag (step S464) and performs the upper region straight line preserving operation to adopt an upper frame of the image as a contour straight line and to preserve the end point information in the main storage unit 6 (step S460).

Then, after the upper region straight line preserving operation (step S460), the correction control module 16 causes the straight line retrieval module 24 to retrieve a straight line which has a length corresponding to one sixth or more of the width of the correction target image within a lower half region of the correction target image, and performs a lower region straight line recognition determination operation to determine whether or not the target straight line can be recognized in the region in question (step S462). In this lower region straight line recognition determination operation (step S462), if the correction control module 16 determines that the target straight line can be recognized, the correction control module 16 performs a lower region straight line preserving operation to preserve end point information in the main storage unit 6 as candidates for contour straight lines (step S466).

In addition, in the lower region straight line recognition determination operation (step S462), if the correction control module 16 determines that no target straight line can be recognized, the correction control module 16 performs a Flag adding operation to add 1 (one) to the Flag (step S468) and performs a Flag determination operation to determine whether or not the total of Flags is less than 2 (two) (step S470). In this Flag determination operation (step S470), if the total of Flags is 2 (two), the correction control module 16 performs the error operation (step S472), whereas if the total of Flags is 1 (one), the correction control module 16 performs a lower region straight line preserving operation to adopt a lower frame of the image as a contour straight line and to preserve the end point information in the main storage unit 6 (step S466), and ends the contour straight line recognition determination operation in the event that the total of Flags is 1 (one) or less.

Namely, the operation of the straight line retrieval module in the horizontal direction correction mode of the straight line portion extraction and correction mode is such that in the event that even only one straight line having the predetermined length or longer can be recognized in the upper and lower half regions of the formed image, the correction becomes possible, and as in the vertical direction correction mode, this horizontal correction mode is effective when attempting to correct a formed image in which the subject is scenery or the like.

In addition, after the contour straight line recognition determination operation (step S450) has ended, the correction control module 16 preserves end point information on the plurality of straight lines recognized in the main storage unit 6 (step S540) and causes the display unit 4 to display the end point information on the plurality of straight lines recognized in the form of dots, and the contour straight line selection module 25 automatically selects from the straight lines recognized, respectively, in the two regions the straight line having the longest length as a best candidate for the contour straight line and draws a straight line which connects between the endpoints of the straight line so selected for display (step S545).

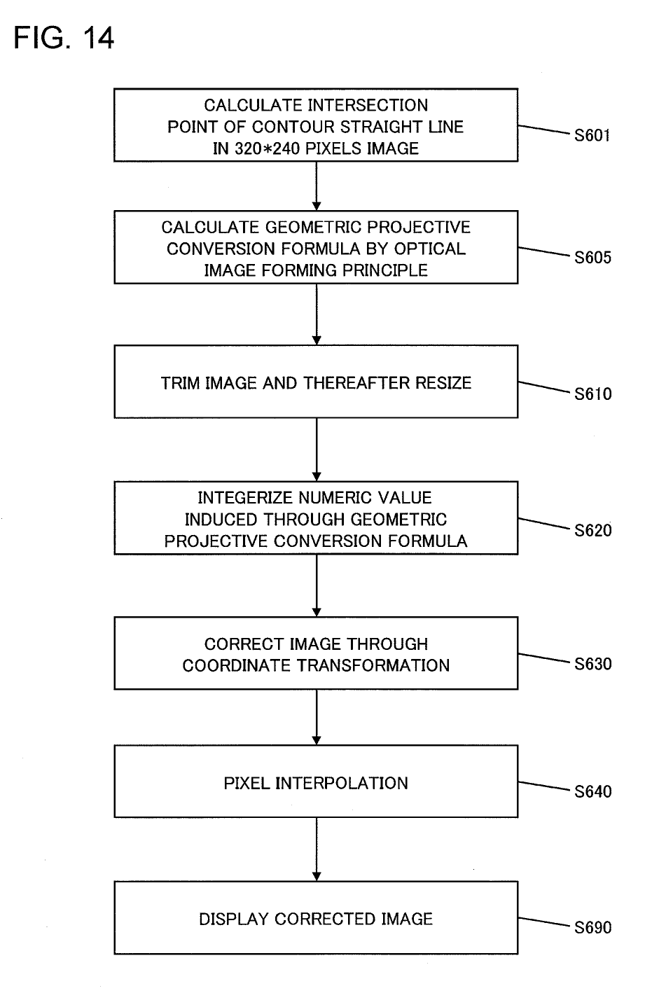

The pixel number reduced image correction and display operation (S600) shown in FIG. 3 will be described using a flowchart shown in FIG. 14. The correction control module 16 performs a pixel number reduced image intersection point calculation operation to cause the intersection point calculation module 31 to calculate intersection points of the contour straight lines recognized within the pixel number reduced image of 320*240 pixels (S601) and performs a geometric projective conversion formula calculation operation to cause the geometric projective conversion formula calculation module 32 to calculate a geometric projective conversion formula based on the optical image forming principle (step S605).

In addition, although in all the correction modes, even in the event that a contour straight line is not recognized in one region, the correction is possible, in order to calculate intersection points in the pixel number reduced image intersection point calculation operation (step S601), a predetermined straight line needs to be determined also in the region where no contour straight line is recognized. Then, in the embodiment, for the region where the recognition of a contour straight line is not possible, an outer frame of the image in the region concerned is adopted as a contour straight line so as to calculate intersection points with the other recognized straight lines.

In addition, in the vertical direction correction mode of the straight line portion extraction and correction mode, since there is no horizontal straight line which intersects with the vertical straight line, the correction control module 16 takes upper and lower frames of the image as contour straight lines and causes the intersection point calculation module 31 to calculate intersection points with the recognized vertical straight lines.

Furthermore, in the horizontal direction correction mode of the straight line portion extraction and correction mode, since there is no vertical line which intersects with the horizontal straight line, the correction control module 16 takes left and right frames of the image as contour straight lines and causes the intersection point calculation module 31 to calculate intersection points with the recognized horizontal straight lines.

Then, the correction control module 16 performs a trimming operation to cause the trimming module 33 to trim the subject which constitutes a correction target on the image, and performs a resizing operation to cause the resize module 34 to resize the image that has been subjected to the trimming operation (step S610). Furthermore, the correction control modules 16 performs an intergerizing operation to cause the intergerizing module 35 to round a numeric value induced by the geometric projective intergerizing formula to an integer (step S620), performs a coordinate transforming operation to cause the coordinate transformation module 36 to correct a distortion in the image through coordinate transformation (step S630), performs a pixel interpolation operation to cause the pixel interpolation module 37 to interpolate pixels (step S640), and performs a post correction pixel number reduced image display operation to cause the main control unit 5 to cause, in turn, the display unit 4 to display thereon an image after the correction (step S690).

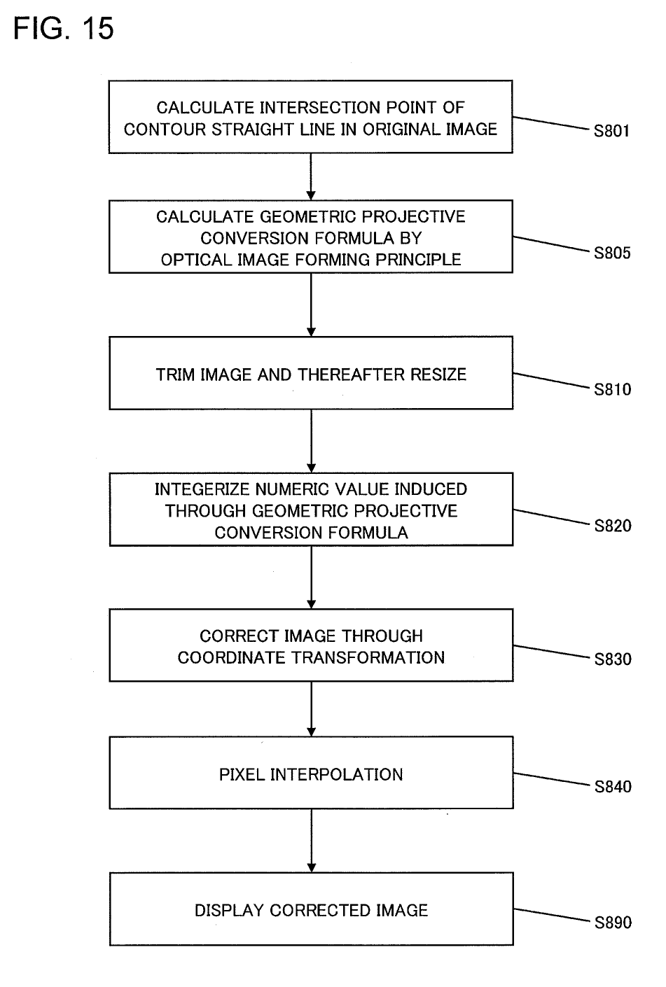

The original image correction and preservation operation (step S800) shown in FIG. 3 will be described using a flowchart shown in FIG. 15. The correction control module 16 performs an original image intersection point calculation operation to cause the intersection point calculation module 31 to calculate intersection points with contour straight lines in an original image which is an image having the number of pixels when it was formed (step S801) and performs a geometric projective conversion formula calculation operation to cause the geometric projective conversion formula calculation module 32 to calculate a geometric projective conversion formula through the optical image forming principle (step S805).

In addition, the correction control module 16 performs a trimming operation to cause the trimming module 33 to trim the subject on the image which constitutes a correction target, and performs a resizing operation to cause the resize module 34 to resize the image that has been subjected to the trimming operation (step S810). In addition, the correction control modules 16 performs an integerizing operation to cause the intergerizing module 35 to round a numeric value induced by the geometric projective conversion formula to an integer (step S820), performs a coordinate transforming operation to cause the coordinate transformation module 36 to correct a distortion in the image through coordinate transformation (step S830), performs a pixel interpolation operation to cause the pixel interpolation module 37 to interpolate pixels (step S840), and performs a post correction pixel number reduced image display operation to cause the main control unit 5 to preserve an image after the correction in the auxiliary storage unit 7 (step S890).

The pixel number reduced image intersection point calculating operation (step S601) shown in FIG. 14 will be described. In general, since a straight line which passes through arbitrary points (X1, Y1) and (X2, Y2) are obtained by Equation (1) below,

$$\frac{x - X 1}{y - Y 1} = \frac{x - X 2}{y - Y 2} Λ \qquad ( 1 )$$

an equation which passes through (X1, Y1) and (X2, Y2) and an equation which passes through (X3, Y3) and (X4, Y4) will be expressed by Equation (2) below,

$$\{ \begin{matrix}\frac{x - X 1}{y - Y 1} = \frac{x - X 2}{y - Y 2} \\ \frac{x - X 3}{y - Y 3} = \frac{x - X 4}{y - Y 4}\end{matrix} \qquad Λ ( 2 )$$

and, when an intersection point between two lines is obtained by Equation (2), Equation (3) results as below,

$$\{ \begin{matrix}x = \frac{( X 3 - X 4 ) ( X 2 Y 1 - X 1 Y 2 ) - ( X 1 - X 2 ) ( X 4 Y 3 - X 3 Y 4 )}{( X 3 - X 4 ) ( Y 1 - Y 2 ) - ( X 1 - X 2 ) ( Y 3 - Y 4 )} \\ y = \frac{( Y 3 - Y 4 ) ( X 2 Y 1 - X 1 Y 2 ) - ( Y 1 - Y 2 ) ( X 4 Y 3 - X 3 Y 4 )}{( X 3 - X 4 ) ( Y 1 - Y 2 ) - ( X 1 - X 2 ) ( Y 3 - Y 4 )}\end{matrix} \qquad Λ ( 3 )$$

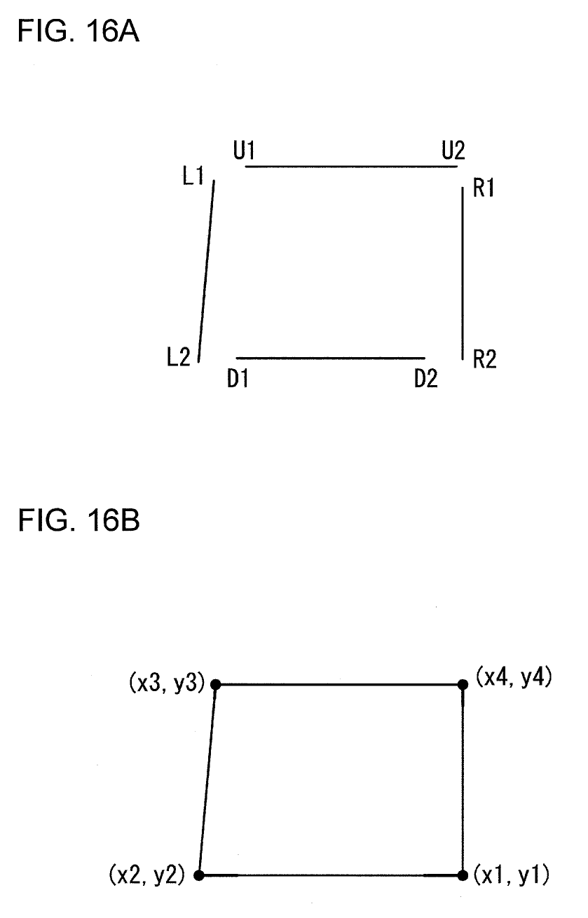

Then, intersection points of four contour straight lines D1D2, L1L2, R1R2, U1U2 shown in FIG. 16A are obtained using Equation (3). As is shown in FIG. 16B, letting an intersection point between D1D2 and R1R2 be (x1, y1), an intersection point between D1D2 and L1L2 be (x2, y2), an intersection point between and U1U2 be (x3, y3), and an intersection point between and R1R2 be (x4, y4), and letting D1(D1X, D1Y), D2(D2X, D2Y), L1(L1X, L1Y), L2(L2X, L2Y), R1(R1X, R1Y), R2(R2X, R2Y), U1(U1X, U1Y) and U2(U2X, U2Y), the following will result;

$$x 1 = \frac{\begin{matrix}( R 1 X - R 2 X ) ( D 2 X * D 1 Y - D 1 X * D 2 Y ) - \\ ( D 1 X - D 2 X ) ( R 2 X * R 1 X - R 1 X * R 2 Y )\end{matrix}}{( R 1 X - R 2 X ) ( D 1 Y - D 2 Y ) - ( D 1 X - D 2 X ) ( R 1 Y - R 2 Y )}$$

$$y 1 = \frac{\begin{matrix}( R 1 Y - R 2 Y ) ( D 2 X * D 1 Y - D 1 X * D 2 Y ) - \\ ( D 1 Y - D 2 Y ) ( R 2 X * R 1 Y - R 1 X * R 2 Y )\end{matrix}}{( R 1 X - R 2 X ) ( D 1 Y - D 2 Y ) - ( D 1 X - D 2 X ) ( R 1 Y - R 2 Y )}$$

$$x 2 = \frac{\begin{matrix}( L 1 X - L 2 X ) ( D 2 X * D 1 Y - D 1 X * D 2 Y ) - \\ ( D 1 X - D 2 X ) ( L 2 X * L 1 Y - L 1 X * L 2 Y )\end{matrix}}{( L 1 X - L 2 X ) ( D 1 Y - D 2 Y ) - ( D 1 X - D 2 X ) ( L 1 Y - L 2 Y )}$$

$$y 2 = \frac{\begin{matrix}( L 1 Y - L 2 Y ) ( D 2 X * D 1 Y - D 1 X * D 2 Y ) - \\ ( D 1 X - D 2 X ) ( L 2 X * L 1 Y - L 1 X * L 2 Y )\end{matrix}}{( L 1 X - L 2 X ) ( D 1 Y - D 2 Y ) - ( D 1 X - D 2 X ) ( L 1 Y - L 2 Y )}$$

$$x 3 = \frac{\begin{matrix}( L 1 X - L 2 X ) ( U 2 X * U 1 Y - U 1 X * U 2 Y ) - \\ ( U 1 X - U 2 X ) ( L 2 X * L 1 X - L 1 X * L 2 Y )\end{matrix}}{( L 1 X - L 2 X ) ( U 1 Y - U 2 Y ) - ( U 1 X - U 2 X ) ( L 1 Y - L 2 Y )}$$

$$y 3 = \frac{\begin{matrix}( L 1 X - L 2 X ) ( U 2 X * U 1 Y - U 1 X * U 2 Y ) - \\ ( U 1 X - U 2 X ) ( L 2 X * L 1 Y - L 1 X * L 2 Y )\end{matrix}}{( L 1 X - L 2 X ) ( U 1 Y - U 2 Y ) - ( U 1 X - U 2 X ) ( L 1 Y - L 2 Y )}$$

$$x 4 = \frac{\begin{matrix}( R 1 X - R 2 X ) ( U 2 X * U 1 Y - U 1 X * U 2 Y ) - \\ ( U 1 X - U 2 X ) ( R 2 X * R 1 Y - R 1 X * R 2 Y )\end{matrix}}{\begin{matrix}( R 1 X - R 2 X ) ( U 1 Y - U 2 Y ) - \\ ( U 1 X - U 2 X ) ( R 1 Y - R 2 Y )\end{matrix}}$$

$$y 4 = \frac{\begin{matrix}( R 1 Y - R 2 Y ) ( U 2 X * U 1 Y - U 1 X * U 2 Y ) - \\ ( U 1 Y - U 2 Y ) ( R 2 X * R 1 Y - R 1 X * R 2 Y )\end{matrix}}{\begin{matrix}( R 1 X - R 2 X ) ( U 1 Y - U 2 Y ) - \\ ( U 1 X - U 2 X ) ( R 1 Y - R 2 Y )\end{matrix}}$$

and coordinates of the respective intersection points are calculated from them.

Letting the number of pixels of the formed image when it was formed be a*b and a coefficient between the original image and the pixel number reduced image of 320*240 be K, the coordinates of the intersection points of the original image obtained by the original image intersection point calculation operation (step S801) shown in FIG. 15 are expressed by K=a/320. Consequently, the intersection point of the contour straight lines of the original image which correspond to the intersection points of the contour straight lines on the pixel number reduced image shown in FIG. 14 which were obtained in the intersection point calculation operation (step S601) will be as follows;

X1=K*x1

Y1=K*y1

X2=K*x2

Y2=K*y2

X3=K*x3

Y3=K*y3

X4=K*x4

Y4=K*y4

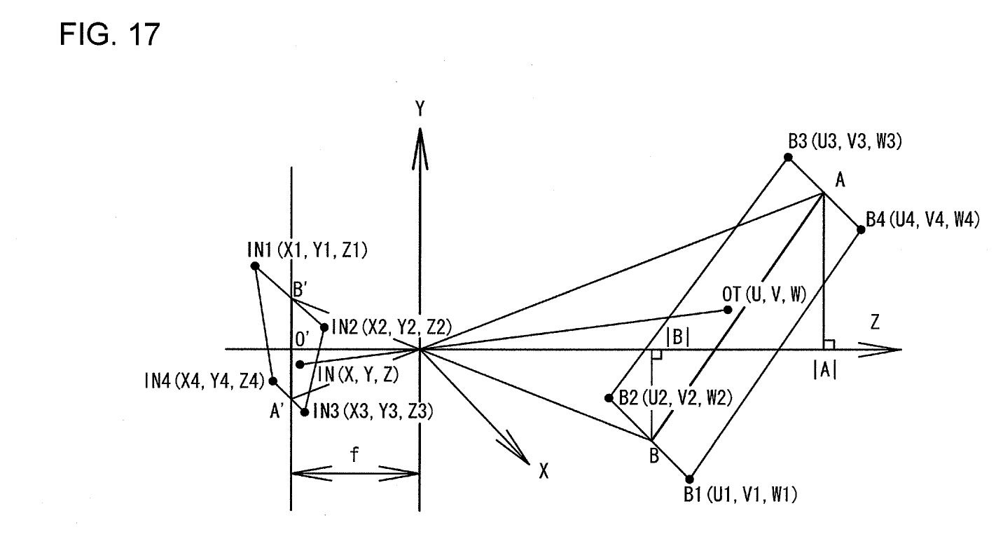

A calculation method of a geometric projective conversion formula in the geometric projective conversion formula calculation operation by the geometric projective conversion formula calculation module 32 (step S605, step S805) shown in FIGS. 14 and 15 will be described. As is shown in FIG. 17, letting four apex coordinates of a rectangular subject be B1(U1, V1, W1), B2(U2, V2, W2), B3(U3, V3, W3), B4(U4, V4, W4), and apex coordinates corresponding, respectively, to these B1, B2, B3, B4 on the CCD or CMOS be IN1(X1, Y1, Z1), IN2(X2, Y2, Z2), IN3(X3, Y3, Z3), IN4(X4, Y4, Z4), since these four points lie on the flat plane, Z1=Z2=Z3=Z4=−f, and furthermore, Equations (4) to (8) are established.

$$\begin{matrix}\frac{X 1}{U 1} = \frac{- f}{W 1} , \frac{Y 1}{V 1} = \frac{- f}{W 1} & Λ ( 4 ) \\ \frac{X 2}{U 2} = \frac{- f}{W 2} , \frac{Y 2}{V 2} = \frac{- f}{W 2} & Λ ( 5 ) \\ \frac{X 3}{U 3} = \frac{- f}{W 3} , \frac{Y 3}{V 3} = \frac{- f}{W 3} & Λ ( 6 ) \\ \frac{X 4}{U 4} = \frac{- f}{W 4} , \frac{Y 4}{V 4} = \frac{- f}{W 4} & Λ ( 7 ) \\ \{ \begin{matrix}U 4 - U 3 = U 1 - U 2 \\ V 4 - V 3 = V 1 - V 2 \\ W 4 - W 3 = W 1 - W 2\end{matrix} & Λ ( 8 )\end{matrix}$$

If K1=W1/−f, K2=W2/−f, K3=W3/−f, and when putting them in Equations (4) to (8) for consolidation, Equation (9) will be established as below,

$$\{ \begin{matrix}( K 1 - K 2 + K 3 ) X 4 = K 1 X 1 - K 2 X 2 + K 3 X 3 \\ ( K 1 - K 2 + K 3 ) Y 4 = K 1 Y 1 - K 2 Y 2 + K 3 Y 3\end{matrix} \qquad Λ ( 9 )$$

In this case, if a=K2/K1, b=K3/K1, and when putting them in Equation (9) to solve it for a and b, Equation (10) will results as below,

$$\{ \begin{matrix}a = \frac{( Y 3 - Y 4 ) ( X 1 - X 4 ) - ( X 3 - X 4 ) ( Y 1 - Y 4 )}{( Y 3 - Y 4 ) ( X 2 - X 4 ) - ( X 3 - X 4 ) ( Y 2 - Y 4 )} \\ b = \frac{( Y 2 - Y 4 ) ( X 1 - X 4 ) - ( X 2 - X 4 ) ( Y 1 - Y 4 )}{( Y 3 - Y 4 ) ( X 2 - X 4 ) - ( X 3 - X 4 ) ( Y 2 - Y 4 )}\end{matrix} \qquad Λ ( 10 )$$

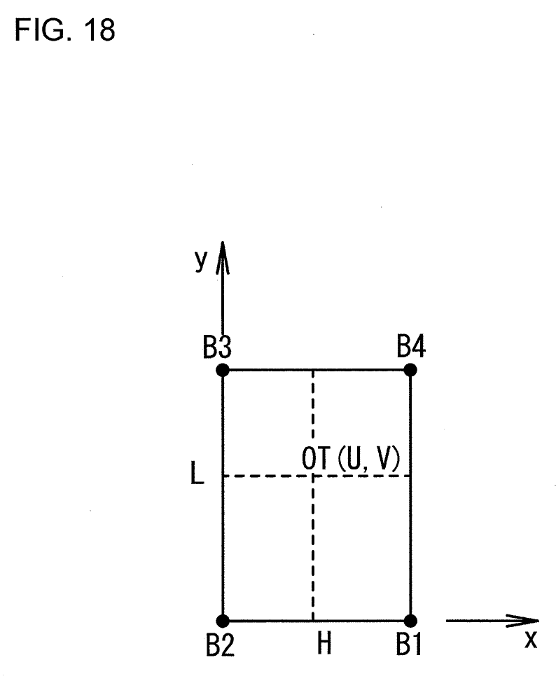

Since the rectangular subject after correction is displayed on the CCD or CMOS as a rectangle B1B2B3B4 as shown in FIG. 18, when a coordinate is set with the straight line B1B2 taken as an x axis and the straight line B2B3 taken as a y axis, an arbitrary point OT(U, V) (U, V may be a negative number) is taken on this plane, and the height and width of the rectangular portion B1B2B3B4 are assumed to be L and H, and if s=U/H, T=V/L, putting them in the rectangular portion B1B2B3B4 of the subject in FIG. 17 to consider the point OT establishes Equation (11).

$$\{ \begin{matrix}U = U 2 + ( U 1 - U 2 ) S + ( U 3 - U 2 ) T \\ V = V 2 + ( V 1 - V 2 ) S + ( V 3 - V 2 ) T \\ W = W 2 + ( W 1 - W 2 ) S + ( W 3 - W 2 ) T\end{matrix} \qquad Λ ( 11 )$$

In addition, assuming that a point on the formed image which corresponds to the point OT(U, V, W) on the rectangular portion B1B2B3B4 of the subject in FIG. 17 is IN(X, Y, Z), that is, IN(X, Y, −f), then, from Equation (4), Equation (12) is obtained as follows

$$\frac{X}{U} = \frac{- f}{W} , \frac{Y}{V} = \frac{- f}{W} \qquad Λ ( 12 )$$

and from Equations (11) and (12), Equation (13) is given as bellow.

$$\{ \begin{matrix}\begin{matrix}\frac{U 2 + ( U 1 - U 2 ) S + ( U 3 - U 2 ) T}{X} = \\ \frac{W 2 + ( W 1 - W 2 ) S + ( W 3 - W 2 ) T}{- f}\end{matrix} \\ \begin{matrix}\frac{V 2 + ( V 1 - V 2 ) S + ( V 3 - V 2 ) T}{Y} = \\ \frac{W 2 + ( W 1 - W 2 ) S + ( W 3 - W 2 ) T}{- f}\end{matrix}\end{matrix} \qquad Λ ( 13 )$$

Furthermore, in Equations (4) to (6), and (13), if K1=W1/−f, K2=W2/−f, K3=W3/−f, Equation (14) is given as below.

$$\{ \begin{matrix}\frac{\begin{matrix}K 2 X 2 + ( K 1 X 1 - K 2 X 2 ) S + \\ ( K 3 X 3 - K 2 X 2 ) T\end{matrix}}{X} = K 2 + ( K 1 - K 2 ) S + ( K 3 - K 2 ) T \\ \frac{\begin{matrix}K 2 Y 2 + ( K 1 Y 1 - K 2 Y 2 ) S + \\ ( K 3 Y 3 - K 2 Y 2 ) T\end{matrix}}{Y} = K 2 + ( K 1 - K 2 ) S + ( K 3 - K 2 ) T\end{matrix} \qquad Λ ( 14 )$$

In Equation (14), if a=K2/K1, b=K3/K1, and when they are solved for S and T, Equation (15) is obtained as follows.

$$\{ \begin{matrix}S = \frac{\begin{matrix}a ( X - X 2 ) ( aY 2 - aY + bY - bY 3 ) - \\ a ( Y - Y 2 ) ( aX 2 - aX + bX - bX 3 )\end{matrix}}{\begin{matrix}( X 1 - X + aX - aX 2 ) ( aY 2 - aY + bY - bY 3 ) - \\ ( Y 1 - Y + aY - aY 2 ) ( aX 2 - aX + bX - bX 3 )\end{matrix}} \\ T = \frac{\begin{matrix}a ( X - X 2 ) ( Y 1 - Y + aY - aY 2 ) - \\ a ( Y - Y 2 ) ( X 1 - X + aX - aX 2 )\end{matrix}}{\begin{matrix}( X 1 - X + aX - aX 2 ) ( aY 2 - aY + bY - bY 3 ) - \\ ( Y 1 - Y + aY - aY 2 ) ( aX 2 - aX + bX - bX 3 )\end{matrix}}\end{matrix} \qquad Λ ( 15 )$$

In addition, when it is solved for X and Y, Equation (16) is given as below.

$$\{ \begin{matrix}X = \frac{aX 2 + ( X 1 - aX 2 ) S + ( bX 3 - aX 2 ) T}{a + ( 1 - a ) S + ( b - a ) T} \\ Y = \frac{aY 2 + ( Y 1 - aY 2 ) S + ( bY 3 - aY 2 ) T}{a + ( 1 - a ) S + ( b - a ) T}\end{matrix} \qquad Λ ( 16 )$$

Thus, it is seen that an aspect ratio of the rectangular subject is expressed by Equation (17).

$$\begin{matrix}\frac{L}{H} = \frac{B 2 B 3}{B 3 B 1} \\ = \sqrt{\frac{{( U 3 - U 2 )}^{2} + {( V 3 - V 2 )}^{2} + {( W 3 - W 2 )}^{2}}{{( U 1 - U 2 )}^{2} + {( V 1 - V 2 )}^{2} + {( W 1 - W 2 )}^{2}}} \\ = \sqrt{\frac{{( K 3 X 3 - K 2 X 2 )}^{2} + {( K 3 Y 3 - K 2 Y 2 )}^{2} + {( K 3 f - K 2 f )}^{2}}{{( K 1 X 1 - K 2 X 2 )}^{2} + {( K 1 Y 1 - K 2 Y 2 )}^{2} + {( K 1 f - K 2 f )}^{2}}} \\ = \sqrt{\frac{{( bX 3 - aX 2 )}^{2} + {( bY 3 - aY 2 )}^{2} + {( bf - af )}^{2}}{{( X 1 - aX 2 )}^{2} + {( Y 1 - aY 2 )}^{2} + {( f - af )}^{2}}} \end{matrix} \qquad Λ ( 17 )$$

The trimming operation and resizing operation (step S610, step S810) performed, respectively, by the trimming module 33 and resizing module 34 shown in FIGS. 14 and 15 will be described below. Note that since these operations are different in the rectangular portion extraction and correction mode and the straight line portion extraction and correction mode, they will be described separately.

In the rectangular portion extraction and correction mode, when correcting the formed image in which the whiteboard or business card is the subject, the correction control module 16 causes the trimming module 33 to trim the portion of the formed image which corresponds to the whiteboard or business card, so as to delete the other images. Then, the correction control module 16 causes the resize module 34 to resize the image remaining after the trimming to an image having the same number of pixels as that before the trimming.

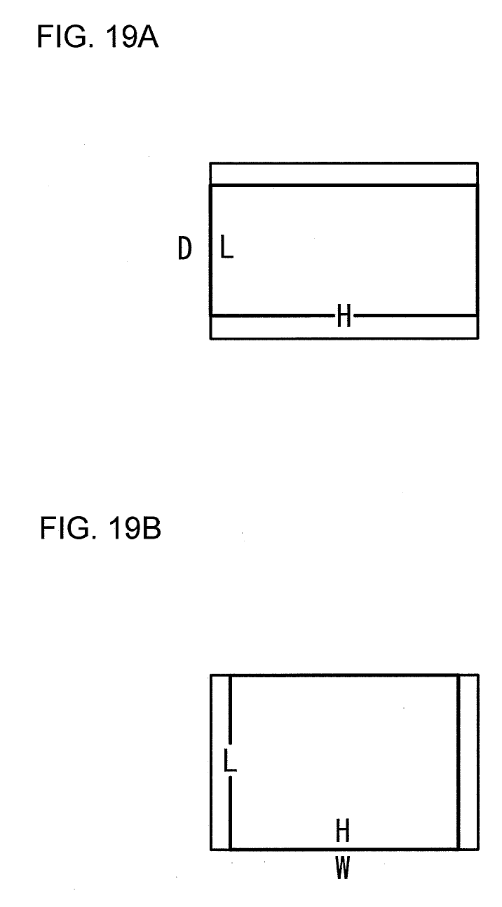

In addition, since the display screen of the standard display unit 4 has an aspect ratio of 3 to 4, when resizing the image, comparing the aspect ratio L/H of the rectangular subject that is obtained by Equation (17) with the aspect ratio of 3 to 4 of the standard display screen, and in the event that it is found from the result of the comparison that the aspect ratio L/H of the rectangular subject is smaller than the aspect of ratio of 3 to 4 of the standard display screen, as is shown in FIG. 19A, the trimmed image is resized so that the horizontal length H of the rectangular subject becomes the same as the horizontal length of the display screen, and a predetermined background color is inserted into upper and lower end portions of the image.

On the contrary, in the event that the aspect ratio L/H of the rectangular subject is larger than the aspect of ratio of 3 to 4 of the standard display screen, as is shown in FIG. 19B, the trimmed image is resized so that the vertical length L of the rectangular subject becomes the same as the vertical length of the display screen, and a predetermined background color is inserted into left and right end portions of the image.

When correcting the formed image in which the subject is a building or scenery in the straight line portion extraction and correction mode, being different from the subject being the business card or the like, since not only the inside of the contour that is determined by making use of the straight lines that have been retrieved to be recognized but also the outside of the contour constitute the important subjects, it needs to be determined how the four apexes which constitute the references for trimming are taken, and the trimming module 33 is made to perform the trimming and the resize module 34 is made to resize according to the predetermined four apexes that are so determined.

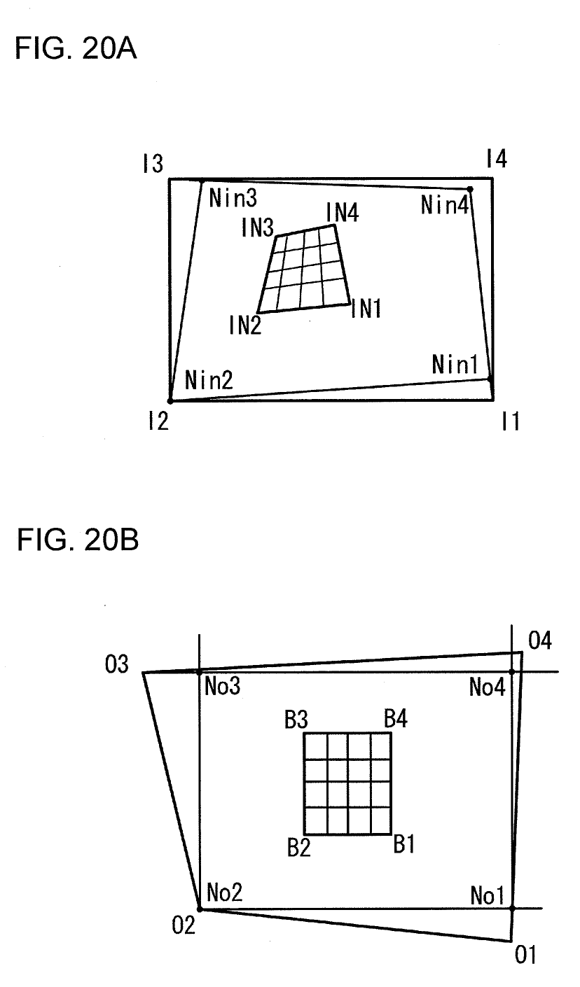

Namely, as is shown in FIG. 20A, the correction control module 16 calculates S, T values which correspond to four apexes I1, I2, I3, I4 of the image by Equation (15) and calculates Max(S2, S3), Min(S1, S4), Max (T1, T2), Min (T3, T4) from the S, T values so calculated, so as to obtain apexes O1, O2, O3, O4 after correction shown in FIG. 20B which correspond to the apexes I1, I2, I3, I4, respectively. Then, apexes No1, No2, No3, No4 of a maximum rectangular region within the region surrounded by the apexes O1, O2, O3, O4 after correction are obtained.

Furthermore, the correction control module 16 calculates four points Nin1, Nin2, Nin3, Nin4 of the original image shown in FIG. 20A which correspond, respectively, to the apexes No1, No2, No3, No4 after correction by Equation (16) and performs similar operations to the trimming and resizing in the contour portion extraction and correction mode using the four points Nin1, Nin2, Nin3, Nin4 as apexes of the image after correction.

The integerizing operation (step S620, step S820) by the intergerizing module 35 shown in FIGS. 14 and 15 will be described. This operation is a calculation using Equation (16), and the calculation is performed within the digital camera. Due to this, since Equation (16) is made simple so as to increase a calculation speed, letting C1=aX2, C2=(X1−aX2), C3=(bX3−aX2), C4=(1−a), C5=(b−a), C6=aY2, C7=(Y1−aY2), and C8=(bY3−aY2), Equation (16) is re-expressed into Equation (18) as below,

$$\{ \begin{matrix}X = \frac{C 1 + C 2 S + C 3 T}{a + C 4 S + C 5 T} \\ Y = \frac{C 6 + C 7 S + C 8 T}{a + C 4 S + C 5 T}\end{matrix} \qquad Λ ( 18 )$$

When the image is actually processed, since the image needs to be processed pixel by pixel, in the event that numeric values that are to be used in Equation (18) includes those including decimal points, load has to be borne by an operation module of the digital camera. Consequently, primary numeric numbers are subjected to an int32 type integerizing operation in the C-language. In addition, letting vertical and horizontal lengths of the image corrected through the geometric projective conversion be L, H, respectively, taking an arbitrary pixel P(i, j) on the image, and letting the values of S, T be i/H, j/L (0≦i≦H, 0≦j≦L), calculations C1 to C8 are performed in the integerizing operation.

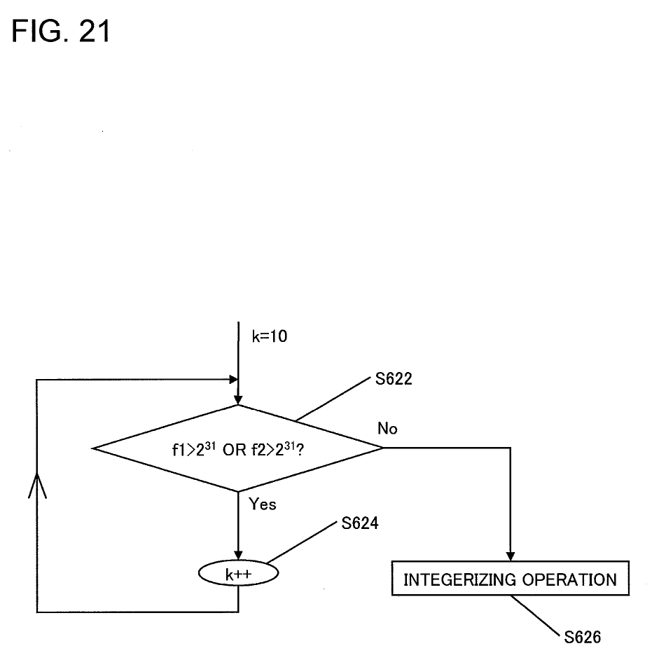

Here, since C2 and C8 are relatively large numeric values from C1 to C8, assuming f1=C2*L*10/k, f2=C8*H*10/k, the correction control module 16 performs an operation shown in a flowchart in FIG. 21 to calculate a value for k. Namely, the correction control module 16 performs an operation to determine whether or not f1>2³¹ or f2>2³¹ with k=10 (step S622), and if f1>2³¹ or f2>2³¹, the correction control module 16 performs an operation to add 1 (one) to k at one time (step S624) and causes these operations to be looped until f1>2³¹ or f2>2³¹ cannot be established so as to calculate a value for k. In addition, the correction control module 16 causes the integerizing module 35 to perform the integerizing operation using the value of k resulting when f1>2³¹ and f2>2³¹ cannot be established (step S626).

Then, by the integerizing operation described above,

N_{—}C1=C1*H*L*10/k

N_{—}C2=C2*L*10/k

N_{—}C3=C3*H*10/k

N_{—}C4=C4*L*10/k

N_{—}C5=C5*H*10/k

N_{—}C6=C6*H*L*10/k

N_{—}C7=C7*L*10/k

N_{—}C8=C8*H*10/k

are calculated. In addition, hereinafter, S, T are substituted by i, j, respectively.

The coordinate transformation operation (step S630, step S830) by the coordinate transformation module 36 shown in FIGS. 14 and 15 will be described. Since the coordinates of the point IN(X, Y) lying on the original image which corresponds to the arbitrary point OT(i, j) on the corrected image can be calculated by the calculations that have been described heretofore, corrections to calculate the point IN(X, Y) lying on the original image which corresponds to the arbitrary point OT(i, j) on the corrected image are performed on all the pixels.

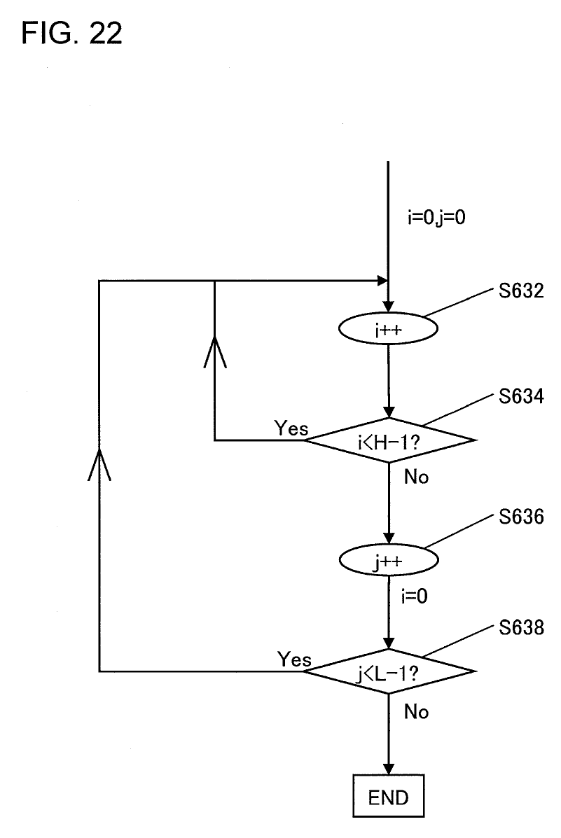

When such corrections are performed on all the pixels, as is shown by a flowchart in FIG. 22, firstly starting from the original point of i=0, j=0, an operation to add 1 (one) to at one time is performed (step S632), a value i determination operation to determine whether or not the value i has reached the value of H is performed (step S634), if the value i is determined in the value i determination operation (step S634) that it has reached H, an operation to add 1 (one) to j to make i=0 again is performed (step S636), and a value j determination operation to determine whether or not the value j has reached L is operated (step S638). In addition, by causing the operations to be looped until the value j reaches L, all the pixels are corrected.

In addition, currently, since the production techniques of CCDs and LCDs are well developed, there exist digital cameras having different numbers of pixels even though they have the same display screen, and therefore, the following operation needs to be performed. Assuming that the number of pixels is A*B, the size of a CCD or an LCD is L*H (mm) and the focal point is f (mm), in the calculations, the coordinates need to be multiplied by L/A or H/B.

The pixel interpolation operation (step S640, step S840) by the pixel interpolation module 37 shown in FIGS. 14 and 15 will be described. Although the coordinates of a pixel unit in the image are represented by integers, numeric values calculated by Equation (18) are generally those including decimal points, and in the event that the integerizing operation is simply performed on those numeric values including decimals to implement the image transformation, there is caused a deterioration in image quality.

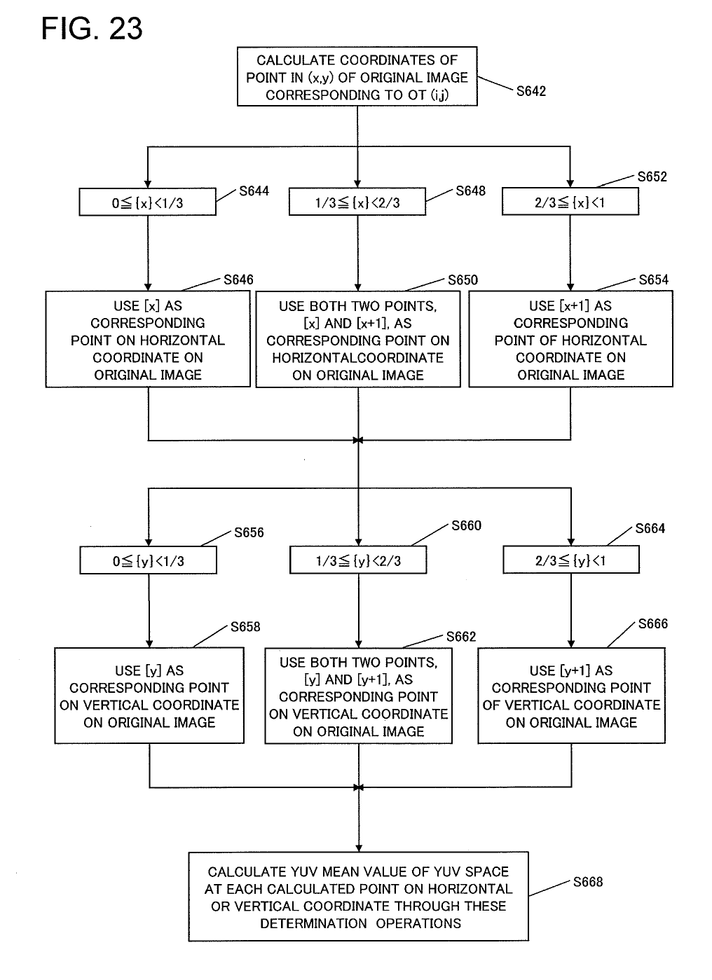

Consequently, letting [x] denote an integer portion of x, {x} a digit's below the decimal point, [y] an integer portion of y, and {y} a digit's below the decimal point, operations shown in a flowchart in FIG. 23 are performed. The pixel interpolation module 37 performs an operation to calculate coordinates of IN(x, y) lying on the original image which corresponds to OT(i, j) (step S642), and if {x} is 0 or more and less than one third (step S644), the pixel interpolation module 37 uses [x] as a corresponding horizontal coordinate lying on the original image (step S646), if {x} is equal to or more than one third and is less than two thirds (step S648), the pixel interpolation module 37 uses both two coordinates of [x] and [x+1] as corresponding horizontal coordinates lying on the original image (step S650), and if {x} is equal to or more than two thirds and is less than 1 (one) (step S652), the pixel interpolation module 37 uses [x+1] as a corresponding horizontal coordinate lying on the original image (step S654).

In addition, in the y coordinate as in the x coordinate, if {y} is equal to or more than 0 and is less than one third (step S656), the pixel interpolation module 37 uses [y] as corresponding vertical coordinate lying on the original image (step S658), if {y} is equal to or more than one third and is less than two thirds (step S660), the pixel interpolation module 37 uses both two coordinates [y] and [y+1] as corresponding vertical coordinates lying on the original image (step S662), and if {y} is equal to or more than two thirds and is less than 1 (one) (step S664), the pixel interpolation module 37 uses [y+1] as a corresponding vertical coordinate lying on the original image.

Namely, assuming that x=1.5, y=1.5, since two points, [x] and [x+1], are used simultaneously as the value of x, x=1, 2, and since two points, [y] and [y+1], are used, y=1, 2, and corresponding coordinates become four points, (x, y)=(1, 1), (1, 2), (2, 1), (2, 2), and IN(x, y) corresponding to OT(i, j) is represented as three types of points such as one point, two points or four points.

The pixel interpolation module 37 calculates a YUV mean value at one point, two points or four points on the original image which satisfy the value of the horizontal coordinate or the vertical coordinate which is determined in the operations above (step S668). Equations to calculate the YUV mean value of the YUV color space in this step S668 are Equations (19) to (21),

$$\begin{matrix}\overline{Y} = \frac{{\sum }_{i = 1}^{n} Y ( xi , yi )}{n} & Λ ( 19 ) \\ \overline{U} = \frac{{\sum }_{i = 1}^{n} U ( xi , yi )}{n} & Λ ( 20 ) \\ \overline{V} = \frac{{\sum }_{i = 1}^{n} V ( xi , yi )}{n} & Λ ( 21 )\end{matrix}$$

In these equations, n denotes the number of points IN(x, y) on the original image which corresponds to OT(i, j). In addition, Y̅, Ū, V̅ which are calculated from the coordinates of IN(x, y) which corresponds to OT(i, j) are used as information on points on the corrected image which corresponds to OT(i, j).

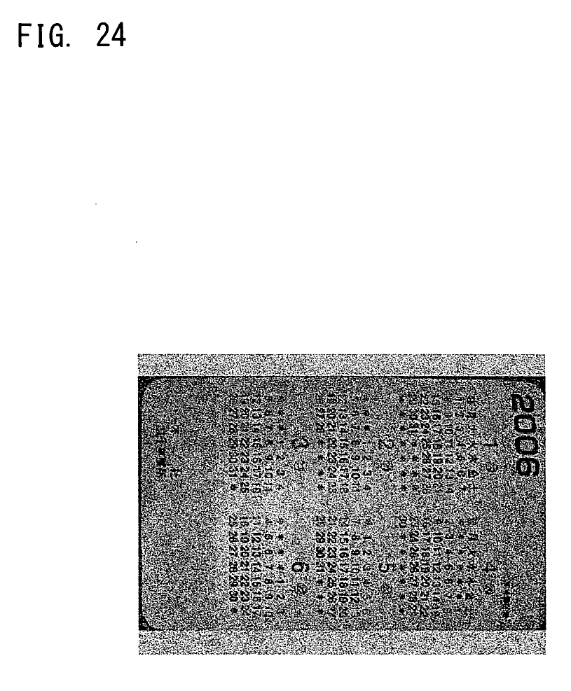

In the event that it is corrected by the distortion correction operation in the rectangular portion extraction and correction mode, the image of the calendar which is distorted as shown in FIG. 5 is corrected so as to be almost free from distortion as is shown in FIG. 24, and furthermore, since the image has been subjected to trimming, the calendar portion is emphasized in the image.

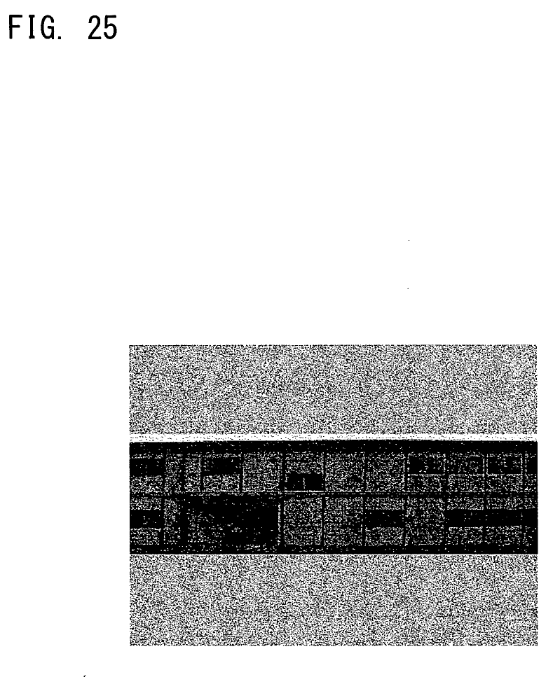

In addition, in the event that the distorted formed image in which the subject is the horizontally long building as is shown in FIG. 7 is corrected by the bidirectional correction mode of the straight line portion extraction and correction mode, as is shown in FIG. 25, the image results in which the horizontal length of the subject is trimmed and resized and the distortion is corrected.

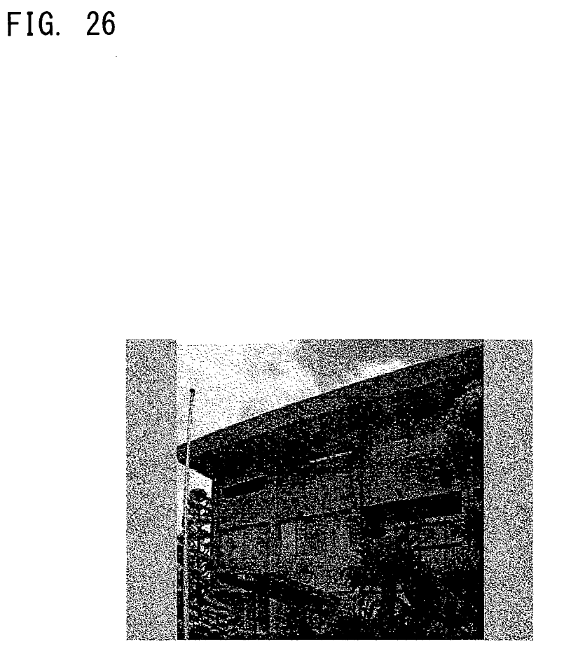

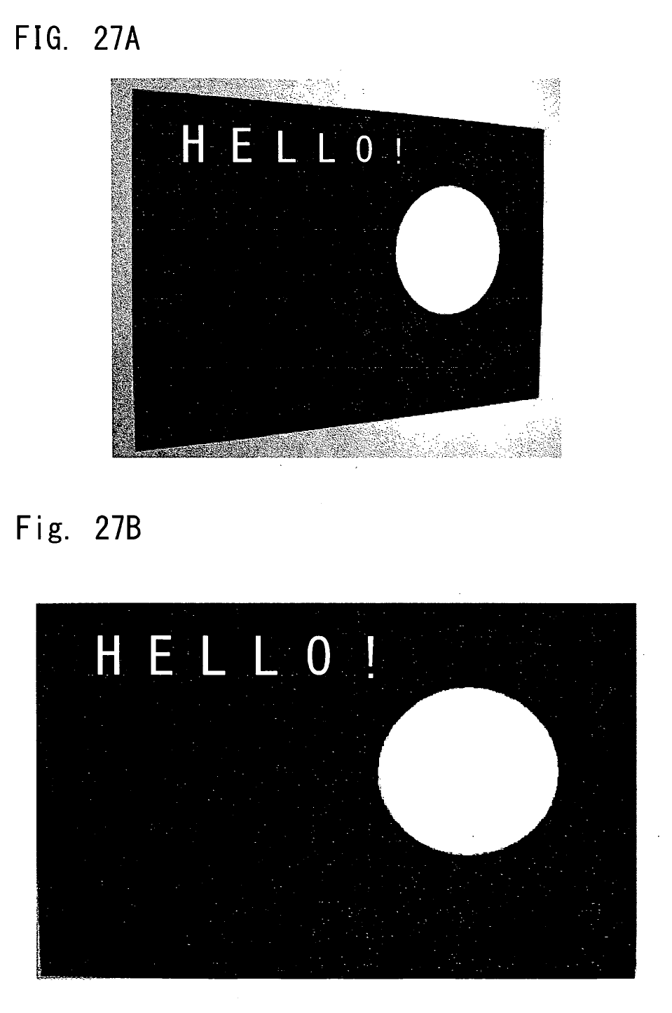

Furthermore, in the event that the distorted formed image in which the subject is the building as is shown in FIG. 8 is corrected by the vertical correction mode of the straight line portion extraction and correction mode, as is shown in FIG. 26, the image results in which the vertical and horizontal dimensions of the building are resized by making use of the vertical and horizontal dimensions of the image frame, and furthermore, the distortion is corrected. Furthermore, the image of the business card that is distorted as is shown in FIG. 27A is corrected to be free from distortion as is shown in FIG. 27B, resulting in the image in which the portion thereof corresponding to the business card is trimmed to be emphasized, and the image of the subject which is a distorted circle is corrected back to a normal circle.

According to the digital camera of the embodiment, since the contour straight line selection module 25 selects the best candidate for the contour straight line from the plurality of straight lines which are retrieved from the image, a distortion correction becomes possible which needs no operation by the photographer. On the other hand, in the event that the photographer changes the candidates for the contour straight lines, since the vertical and horizontal contour straight line candidates can be selected separately in such a way that the horizontal contour straight line candidate is selected after the vertical contour straight line candidate has been selected, even when there are many contour straight line candidates, the number of operations can be reduced, compared to the case where candidates are selected from a plurality of rectangular contours.

For example, in the event that there are four contour straight line candidates in the vertical direction, as well as four contour straight line candidates in the horizontal direction, when selecting candidates from a plurality of rectangular contours, since there exist 16 rectangular contours, 16 operations need to be performed at the most. However, as in the embodiment of the invention, by selecting the vertical and horizontal candidates separately, eight operations, four in the vertical direction and four in the horizontal direction, only have to be performed at the most to select the contour straight line candidates.

In addition, since the vertical contour straight line candidates and the horizontal contour straight line candidates are displayed in the different colors, the contour straight line candidates can easily be identified even on the small liquid crystal display screen provided on the digital camera 1.

Since the correction is performed by reducing the number of pixels of the formed image to transform it into the image of 320*240 pixels, when the photographer operates the icons while looking at the image displayed on the display unit 4, the small date only has to be calculated, and hence, the number of pixels to be involved in calculation is reduced, not much time being thereby taken to complete the operation. Consequently, almost no waiting time is required when performing calculations involved in correction, whereby the photographer is allowed to use the digital camera 1 comfortably.

In addition, since the correction is firstly performed on the pixel number reduced image and is thereafter performed on the corresponding coordinate on the original image, the calculations involved become simpler than when the correction is performed on the original image from the beginning, and in addition, since the correction is implemented by calculating the geometric projective conversion formulae through the optical image forming principle, the calculations are facilitated. Furthermore, since the integerizing operation of the numeric values by the geometric projective conversion module is firstly performed and thereafter the image is corrected through the coordinate transformation, the necessity is obviated of performing calculations involving values including digits below decimal point, and the load borne by the operation module is reduced, whereby even the operation module incorporated in the small digital camera can implement calculations easily.

Furthermore, since the pixel interpolation is performed at the end of the series of correction operations, the corrected image can provide good image quality, and since the correction is performed by trimming the subject, the subject can be displayed largely on the display screen, thereby making it possible to provide the formed image which is easy to be seen.

Note that the invention is not limited to the embodiment that has been described heretofore. For example, in the transformation module adapted to transform the formed image into the image of 320*240 pixels, the number of pixels of the reduced image is not limited to 320*240, and hence a smaller number of pixels or a larger number of pixels may be adopted depending upon the calculation capacity of the DSP (Digital Signal Processor). In addition, in the embodiment, while in the image diving operation by the image dividing module, the image is bisected or trisected, the invention is not limited thereto. Furthermore, in the embodiment, while the conditions for retrieval of contour straight lines are based on one half or one third of the vertical and horizontal lengths of the image, the invention is not limited thereto. Thus, the invention may be modified variously without departing from the sprit and scope thereof.

1. A digital camera comprising:
an imaging unit configured to forming an image of a subject;
a display unit configured to display the image of the subject so formed;
a main control unit configured to control various processing operations;
a distortion correction unit configured to correct a distortion in the formed image;
a main storage unit configured to store image data formed by the imaging unit and processed data of the processing operation performed by the main control unit; and
an auxiliary storage unit configured to store the formed image and corrected image and to be detachable, wherein
the distortion correction unit having:
a contour retrieval module;
an image correction module; and
a correction control module configured to control the contour retrieval module and the image correction module,
the contour retrieval module including:
a pixel number conversion module configured to transform the number of pixels of the formed image;
a color space conversion module for converting a color space;
a dividing module configured to equally divide the image vertically or horizontally;
a straight line retrieval module configured to retrieve a contour straight line; and
a contour straight line selection module configured to select the best candidate from a plurality of contour straight lines retrieved by the straight line retrieval module and to display the candidate on the display unit,
the image correction module including:
an intersection point calculation module configured to calculate intersection points of contour straight lines;
a geometric projective conversion formula calculation module configured to calculate a geometric projective conversion formula;
a trimming module configured to trim the image and a resize module configured to resize the image;
an integerizing module configured to round a numeric value calculated by the geometric projective conversion formula calculation module to an integer;
a coordinate transformation module configured to perform an image correction through coordinate transformation; and
a pixel interpolation module configured to perform a pixel interpolation.

2. A digital camera as set forth in claim 1, wherein
the contour retrieval module performs operations to retrieve contour straight lines in an image of which the number of pixels is reduced by the pixel number conversion module and to obtain end point information in the retrieved contour straight line.

3. A digital camera as set forth in claim 2, wherein
the distortion correction unit performs a rectangular portion extraction and correction mode operation to retrieve contour straight lines of a rectangle made up of four sides by the contour retrieval module for correction and a straight line portion extraction and correction mode operation to retrieve four or less straight lines by the contour retrieval module for correction.

4. A digital camera as set forth in claim 3, wherein
the pixel number conversion module performs an operation to reduce the image having the number of pixels of the formed image into an image having 320*240 pixels.

5. A digital camera as set forth in claim 4, wherein
the contour straight line selection module switches a predetermined contour straight line candidate displayed on the display unit to another contour straight line candidate for display on the display unit through an operation by the photographer.

6. A digital camera as set forth in claim 5, wherein
the contour straight line selection module causes the display unit to display thereon a vertical line and a horizontal line by lines of different colors.
